(19) United States
(12) Patent Application Publication
(10) Pub. No.: US 2004/0128188 A1
(43) Pub. Date: Jul. 1, 2004

(54) System and method for managing employee accountability and performance

(76) Inventors: Brian Leither, Minneapolis, MN (US); Gregory Morrison, Mendota Heights, MN (US); Kristofer Jon Kindem, Bloomington, MN (US)

Correspondence Address: STEPTOE & JOHNSON LLP, 1330 Connecticut Avenue, N.W., Washington, DC, 20036, US

(21) Appl. No.: 10/330,163

(22) Filed: Dec. 30, 2002

(51) Int. Cl. G06F 17/60

(52) U.S. Cl. 705/11

(57) ABSTRACT

Systems and methods for managing employee accountability and performance that include and involve an application server facility including at least one data processing platform configured to store and manage employee data, project management data related to a plurality of projects within an organization including employee evaluation and performance data, accountability data, peer review data, and application data related to a plurality of applications operable in conjunction with the employee data and said project management data. Also included is a client data processing facility coupled to the application server via a network. The client data processing facility is configured to retrieve application data from the application server facility and to facilitate generation of at least one corresponding graphical user interface within the client data processing facility and to permit access to and modification of employee data and project management data based on a predefined security scheme.

### BACKGROUND OF THE INVENTION

1. Technical Field

The present invention relates to automated online systems and methods used to manage employees within an organization and, more particularly, to online systems and methods used to manage employee accountability for assigned tasks against related performance objectives.

2. Related Art

For many years, organizations have faced the challenges of modern business environments by seeking lower costs of business, increased production capacity, higher levels of employee efficiency, managerial improvements, process streamlining, etc. Such challenges have a commonality: reliance on properly tasked employees to efficiently complete and report about work tasks. As such, organizations have long felt the need to devise systems and processes for managing employee accountability for task completion and for monitoring employee performance objectives—all the while staying focused on running profitable organizations or, in the case of non-profit organizations, staying focused on cost control while effectively delivering upon organizational missions.

Such prior systems and processes, however, are not without their problems. For example, integration between systems and processes used to manage employee performance often are not linked to other business units and functions, thus creating disparate systems and the absence of data. It is not uncommon within larger organizations, for example, to have different employee appraisal systems and processes in use by various business units whether they be automated or not.

Such prior systems and processes often lack centralized management of business processes so that managers within an organization have a common understanding and knowledge of business success factors. Such a problem often leads to managers mis-evaluating employees based on factors that either do or-do not apply to particular business functions.

Equally as disturbing, such prior systems and processes often are thought of only at particular times throughout a business period (e.g., annually at the end of a calendar year). For example, organizations often perform employee evaluations annually and rely on systems and processes that require one-time, year-end data collection to gather data to produce employee appraisal reports, make recommendations for employee advancement, adjust salaries, etc.

Additionally, such prior systems and processes often lack contribution of data from multiple levels within an organization. Such a problem often leads to direct-manager-centric employee performance appraisals that often do not take into account data driven by peers (e.g., peer review, etc.) and subordinates that can be used to gain a greater picture of an employee's performance and, more generally, about how an organization and its business practices have performed.

And, despite the inclusion of modern data processing systems into the systems and processes that are used to evaluate employee performance, such data processing systems often are built upon highly specific platforms, do not allow organizational or global data entry and manipulation, are not flexible to changing business environments due the customized nature of such data processing environments, and often are quite costly to implement and maintain.

Finally, prior systems and processes have not heretofore been successfully implemented and made operational within data processing environments employing open standards based technologies such as those used in modern Internet and intranet applications.

These and other problems are squarely addressed and solved by the present invention. And, in particular, the present invention provides new systems and methods for managing employee accountability and performance.

### SUMMARY OF THE INVENTION

The present invention solves the problems associated with the related art as discussed above. In so doing, the present invention provides new and improved systems and methods for managing employee accountability and performance within an organization.

For example, the present invention provides new and improved systems and methods for managing employee accountability and performance within an organization that include and involve an application server facility including at least one data processing platform configured to store and manage employee data, project management data related to a plurality of projects within an organization including employee evaluation and performance data, accountability data, peer review data, and application data related to a plurality of applications operable in conjunction with employee data and said project management data. Such systems and methods also include and involve a client data processing facility coupled to the application server via a network. The client data processing facility is configured to retrieve application data from the application server facility and to facilitate generation of at least one corresponding graphical user interface within the client data processing facility and to permit access to and modification of employee data and project management data based on a predefined security scheme.

According to another aspect of the present invention, provided is a method for managing employee accountability and performance within an organization. Such a method includes the steps of storing and managing employee data, project management data related to a plurality of projects within an organization including employee evaluation and performance data, accountability data, peer review data, and application data related to a plurality of applications operable in conjunction with the employee data and the project management data, and at a client data processing facility, retrieving the application data from an application server facility and facilitating generation of at least one corresponding graphical user interface within the client data processing facility and permitting access to and modification of employee data and project management data based on a predefined security scheme.

And, according to another aspect of the present invention, a system for managing employee accountability and performance is provided and includes an application server facility including at least one data processing platform configured to store and manage employee data, project management data related to a plurality of projects within an organization including employee evaluation and performance data, accountability data, peer review data, and application data related to a plurality of applications operable in conjunction with the employee data and the project management data. The system further includes a client data processing facility coupled to the application server via a network such as the Internet. The client data processing facility is configured to retrieve the application data from the application server facility and to facilitate generation of at least one corresponding graphical user interface within the client data processing facility and to permit access to and modification of employee data and project management data based on a predefined access scheme.

The aforementioned and other features of the present invention are described in detail below with reference to the attached drawing figures which are next briefly described.

### BRIEF DESCRIPTION OF THE DRAWINGS

The present invention is described below in detail with regard to the attached drawing figures, of which:

FIG. 1 is a diagram of a system for managing employee accountability and performance in accordance with an embodiment of the present invention;

FIG. 2 is block diagram of the client side data processing system shown in FIG. 1;

FIG. 3 is a block diagram of the application server system shown in FIG. 1;

FIG. 4 is a process flow chart depicting the overall process steps carried out within the system shown in FIG. 1 to facilitate management of employee accountability and performance within an organization in accordance with a preferred embodiment of the present invention;

FIG. 5A is a screen image of an online application screen forming a graphical user interface facilitated by the system depicted in FIG. 1;

FIG. 5B is a screen image of an online application screen forming a graphical user interface facilitated by the system depicted in FIG. 1;

FIG. 5C is a screen image of an online application screen forming a graphical user interface facilitated by the system depicted in FIG. 1;

FIG. 5D is a screen image of an online application screen forming a graphical user interface facilitated by the system depicted in FIG. 1;

FIG. 5E is a screen image of an online application screen forming a graphical user interface facilitated by the system depicted in FIG. 1;

FIG. 5F is a screen image of an online application screen forming a graphical user interface facilitated by the system depicted in FIG. 1;

FIG. 5G is a screen image of an online application screen forming a graphical user interface facilitated by the system depicted in FIG. 1;

FIG. 5H is a screen image of an online application screen forming a graphical user interface facilitated by the system depicted in FIG. 1;

FIG. 5I is a screen image of an online application screen forming a graphical user interface facilitated by the system depicted in FIG. 1;

FIG. 5J is a screen image of an online application screen forming a graphical user interface facilitated by the system depicted in FIG. 1;

FIG. 5K is a screen image of an online application screen forming a graphical user interface facilitated by the system depicted in FIG. 1;

FIG. 5L is a screen image of an online application screen forming a graphical user interface facilitated by the system depicted in FIG. 1;

FIG. 5M is a screen image of an online application screen forming a graphical user interface facilitated by the system depicted in FIG. 1;

FIG. 5N is a screen image of an online application screen forming a graphical user interface facilitated by the system depicted in FIG. 1;

FIG. 5O is a screen image of an online application screen forming a graphical user interface facilitated by the system depicted in FIG. 1;

FIG. 5P is a screen image of an online application screen forming a graphical user interface facilitated by the system depicted in FIG. 1;

FIG. 5Q is a screen image of an online application screen forming a graphical user interface facilitated by the system depicted in FIG. 1;

FIG. 5R is a screen image of an online application screen forming a graphical user interface facilitated by the system depicted in FIG. 1;

FIG. 5S is a screen image of an online application screen forming a graphical user interface facilitated by the system depicted in FIG. 1;

FIG. 5T is a screen image of an online application screen forming a graphical user interface facilitated by the system depicted in FIG. 1;

FIG. 5U is a screen image of an online application screen forming a graphical user interface facilitated by the system depicted in FIG. 1;

FIG. 5V is a screen image of an online application screen forming a graphical user interface facilitated by the system depicted in FIG. 1;

FIG. 5W is a screen image of an online application screen forming a graphical user interface facilitated by the system depicted in FIG. 1;

FIG. 5X is a screen image of an online application screen forming a graphical user interface facilitated by the system depicted in FIG. 1;

FIG. 5Y is a screen image of an online application screen forming a graphical user interface facilitated by the system depicted in FIG. 1;

FIG. 5Z is a screen image of an online application screen forming a graphical user interface facilitated by the system depicted in FIG. 1;

FIG. 5AA is a screen image of an online application screen forming a graphical user interface facilitated by the system depicted in FIG. 1;

FIG. 5BB is a screen image of an online application screen forming a graphical user interface facilitated by the system depicted in FIG. 1;

FIG. 5CC is a screen image of an online application screen forming a graphical user interface facilitated by the system depicted in FIG. 1;

FIG. 5DD is a screen image of an online application screen forming a graphical user interface facilitated by the system depicted in FIG. 1;

FIG. 5EE is a screen image of an online application screen forming a graphical user interface facilitated by the system depicted in FIG. 1;

FIG. 5FF is a screen image of an online application screen forming a graphical user interface facilitated by the system depicted in FIG. 1;

FIG. 5GG is a screen image of an online application screen forming a graphical user interface facilitated by the system depicted in FIG. 1;

FIG. 5HH is a screen image of an online application screen forming a graphical user interface facilitated by the system depicted in FIG. 1;

FIG. 5II is a screen image of an online application screen forming a graphical user interface facilitated by the system depicted in FIG. 1;

FIG. 5JJ is a screen image of an online application screen forming a graphical user interface facilitated by the system depicted in FIG. 1; and

FIG. 5KK is a screen image of an online application screen forming a graphical user interface facilitated by the system depicted in FIG. 1.

### DETAILED DESCRIPTION OF THE PREFERRED EMBODIMENTS

The detailed description of the preferred embodiments of the present invention that follow refer to the drawing figures briefly described above. A discussion of the structural aspects of the present invention is followed by a corresponding discussion of operational and implementation aspects. Reference numerals have been provided within the drawing figures to aid the reader in reviewing the discussions found below. Like parts are referred to with like reference numerals. And, such reference numerals in no way limit the scope or nature of the present invention as defined in the appended claims.

### Online Systems and Methods for Managing Employee Accountability and Performance Within an Organization

The present invention provides online systems and methods for managing employee accountability and performance within an organization such as a company. Such systems and methods allow expectation setting, progress tracking, self-review, review of peers, development plans, and reviews by management. Because data regarding employee accountability and performance is now available online, what were often static year-end processes have been replaced with dynamic systems and methods that facilitate up-to-the minute management and tracking of performance data. Management and employees within an organization now have the ability to instantly understand job performance of work forces through use of friendly, graphical user environments provided within a common data processing system.

The conceptual components of such systems and methods which have been incorporated into the preferred embodiments discussed herein are as follows:

Expectation Setting—Establishing and aligning Key Business Objectives (KBOs) and Key Success Factors (KSFs) for each person in an organization with established organizational objectives and factors and selecting peers for conduction peer reviews.

Progress Tracking—Recording actions accomplished throughout a reporting period (e.g., a year) by the individual and the supervisor that relate to the completion of the KBOs and KSFs of the organization.

Development Planning—After the first year or other completed reporting period in the performance management cycle, the systems and methods of the present invention can be used to identify developmental priorities and to track progress and completion of the priorities identified.

Self-review—Recording and displaying graphically the person's self review of their performance.

Review of Peers—Allowing multiple peers to review an employee and to allow the employee to review multiple peers also in the process.

Manager Reviews—Allowing managers to review, comment, and rate employees, combining input from peers, a progress log, and the self-review into a final combined review.

Business Logic and security scheme—Implemented rules defined by supporting departments within an organization regarding access, modification rights, constraints to the process, and identification of people using the application (for audit purposes).

Data Storage and Retrieval—Efficiently store information entered into the systems for retrieval and import into final reviews.

Reporting—Provide summary reports on system usage, participation, and statistical details as required by management teams for tracking and evaluating the applications provided and their processes.

Interfaces to existing databases—Connect when possible to existing databases that have relevant information for security or performance of individual.

On-line training—Provide just-in-time training as needed initially via text help files giving examples and explanation.

Wizard applications to assist in completing processes—Eventually provide assistance applications that can be triggered to assist people when the next step in the process is not clear.

Data mining and ad hoc report query tools—Production usage of the systems and methods provided will compile information of interest to management for effectiveness analysis.

Such features have been implemented into exemplary embodiments as shown in the attached drawing figures to which reference is now made.

### Structural Aspects of the Present Invention

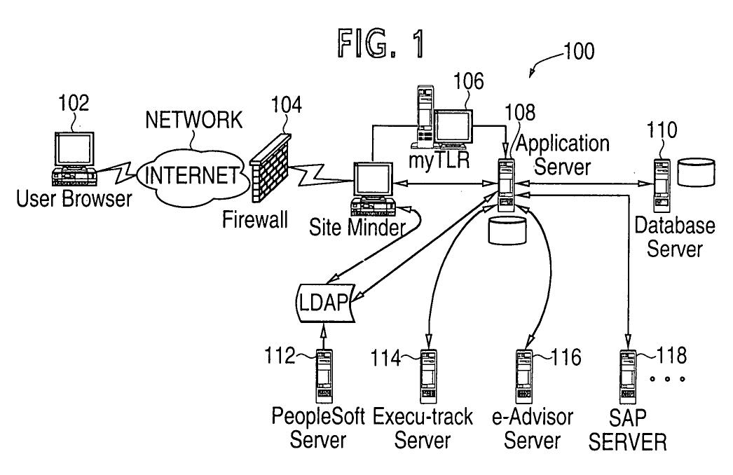

Referring now to FIG. 1, depicted therein is a diagram of a system for managing employee accountability and performance in accordance with a preferred embodiment of the present invention. The particular system architecture shown in FIG. 1 is modeled on a three-tier thin-client framework. In such a framework, a thin client (e.g., a web browser application) running on a user's computer system contacts and is validated by an online, front-end interface 106 which is responsible for providing network security and access control. Network connections are facilitated by a Virtual Private Network (VPN) using the Internet, a company based Wide Area Network (WAN), internal networks, via secure dial-up connections, etc. Such VPN access as well as access to the applications running within system 100 to facilitate management of employee accountability and performance within an organization is based on a pre-defined security and/or access scheme that contemplates the organizational position of a user prior to granting access rights to that user. For example, managers may have greater access rights than do employees, etc.

Once access is granted by front-end interface 106, a user may connect to the remainder of system 100 and, in particular, the data applications operational therein via a link on a corresponding front-end home page (e.g., a web page accessible to users validated and authorized to engage in employee accountability and performance tracking, etc.). In particular, when such link is traversed (also referred to as “clicked”) the user may be validated via a security model for access to the applications running within system 100. Such access will facilitate provisioning of graphical user interfaces in the form of interactive online screens within a browser application running within a web browser application much like online forms are provisioned in web download session (e.g., one like or similar to traversal of a web site such as www.uspto.gov, etc.).

Upon validation, a new frame set (e.g., such as those implemented via open-standards based web pages, etc.) so that applications and corresponding graphical user interfaces may be displayed on and within a user's client such as within a browser application such as Microsoft® Internet Explorer™ V.6.0. The applications for managing and processing data related to employee accountability and performance facilitate generation of online screens using Java Server Pages (JSP) technology. Data to be displayed on the screen is requested from the database running on a separate server such as database server 110. The business logic pages used before call for data first validate user permission's to view, add, delete, and modify requested data.

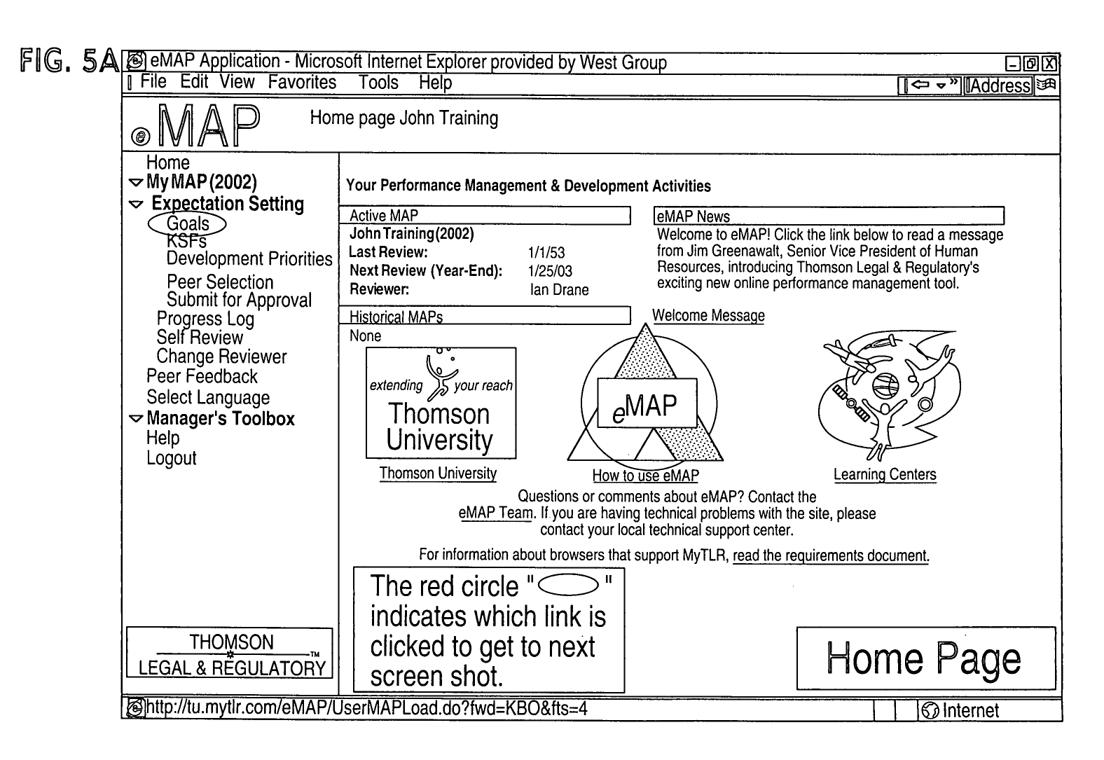

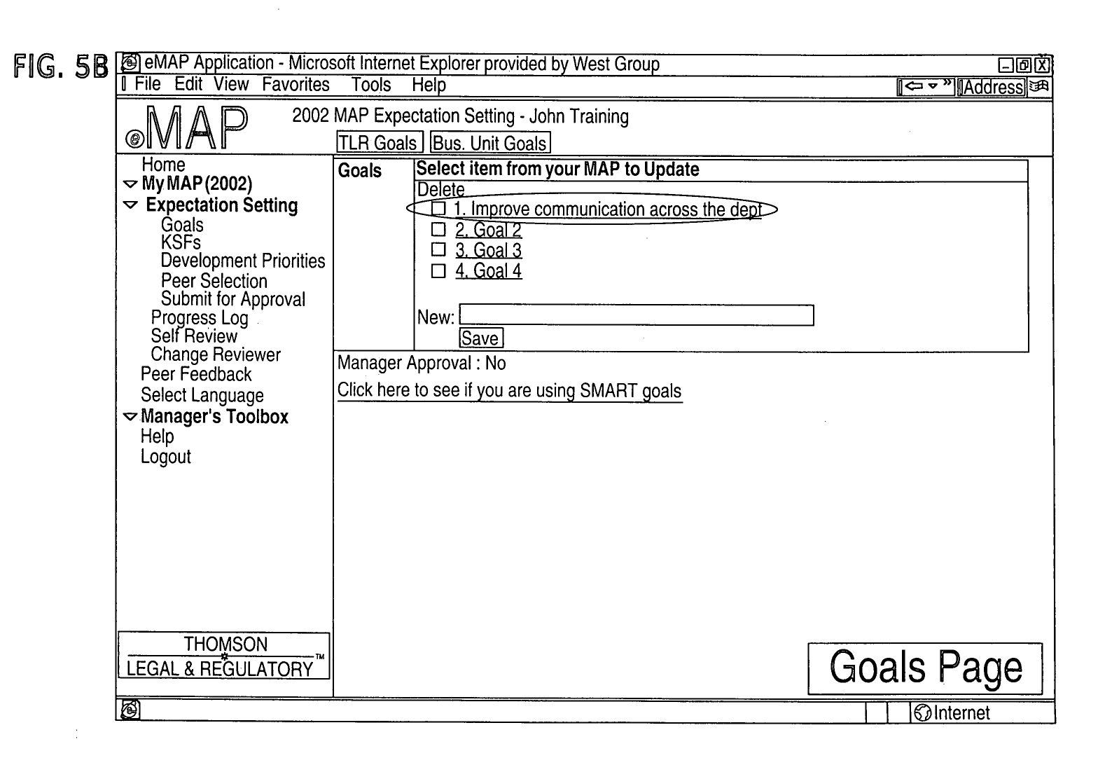

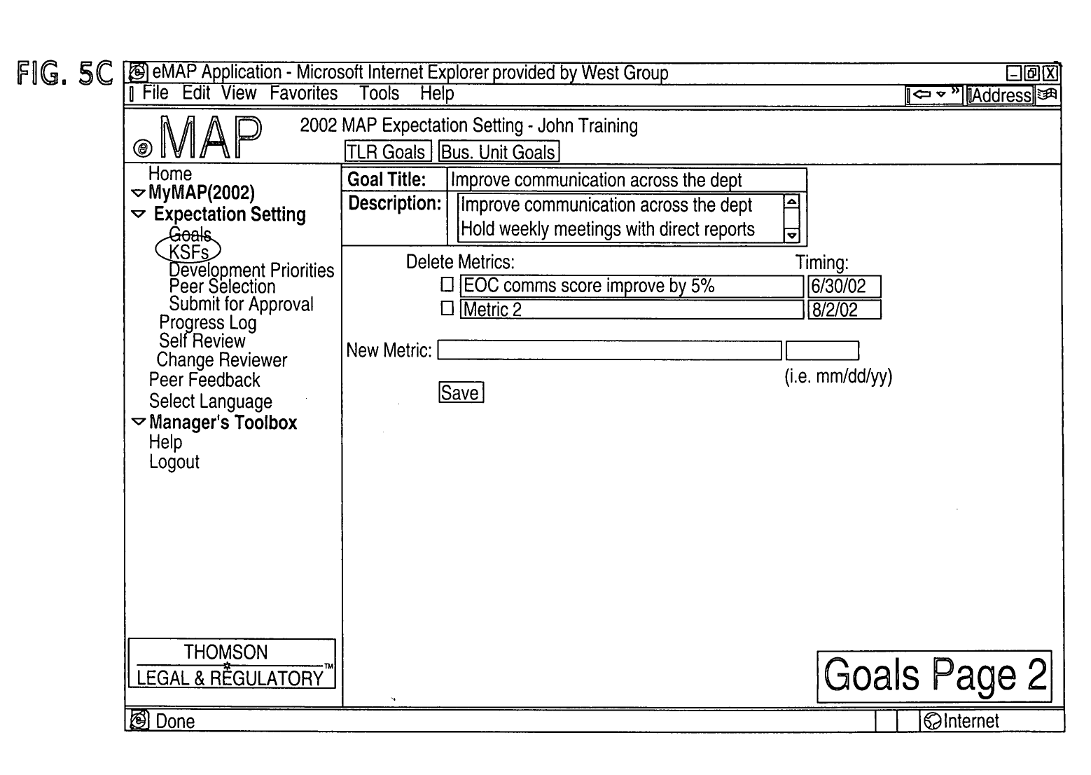

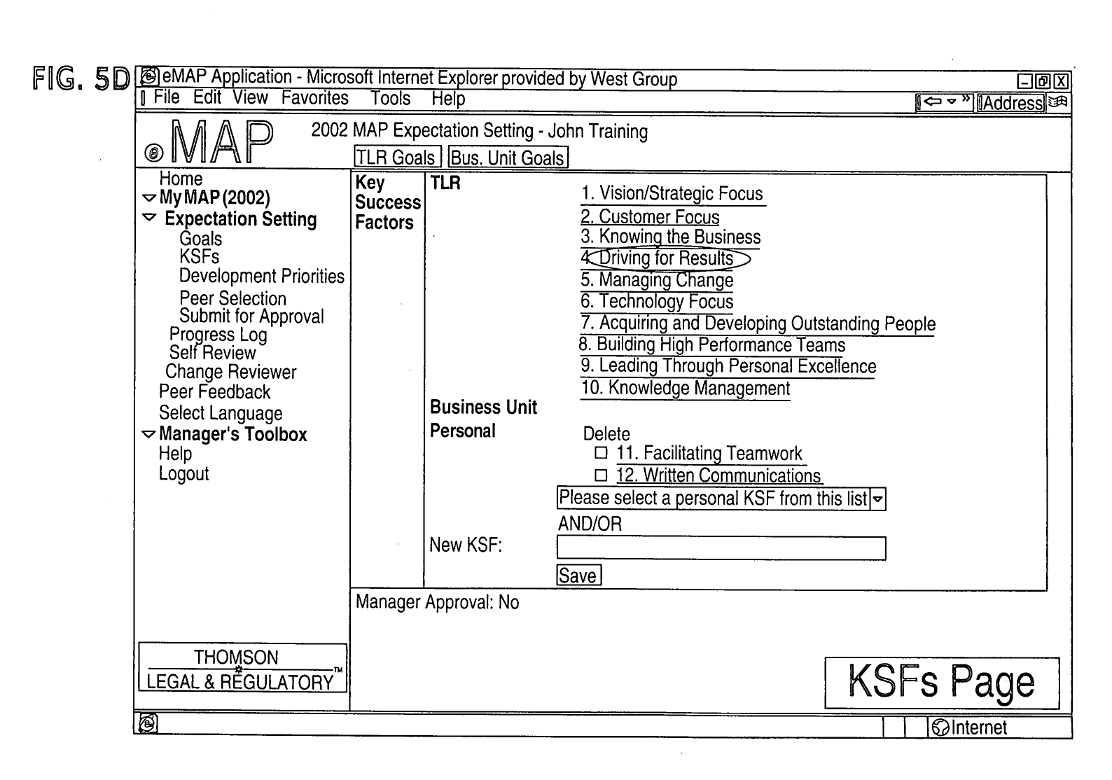

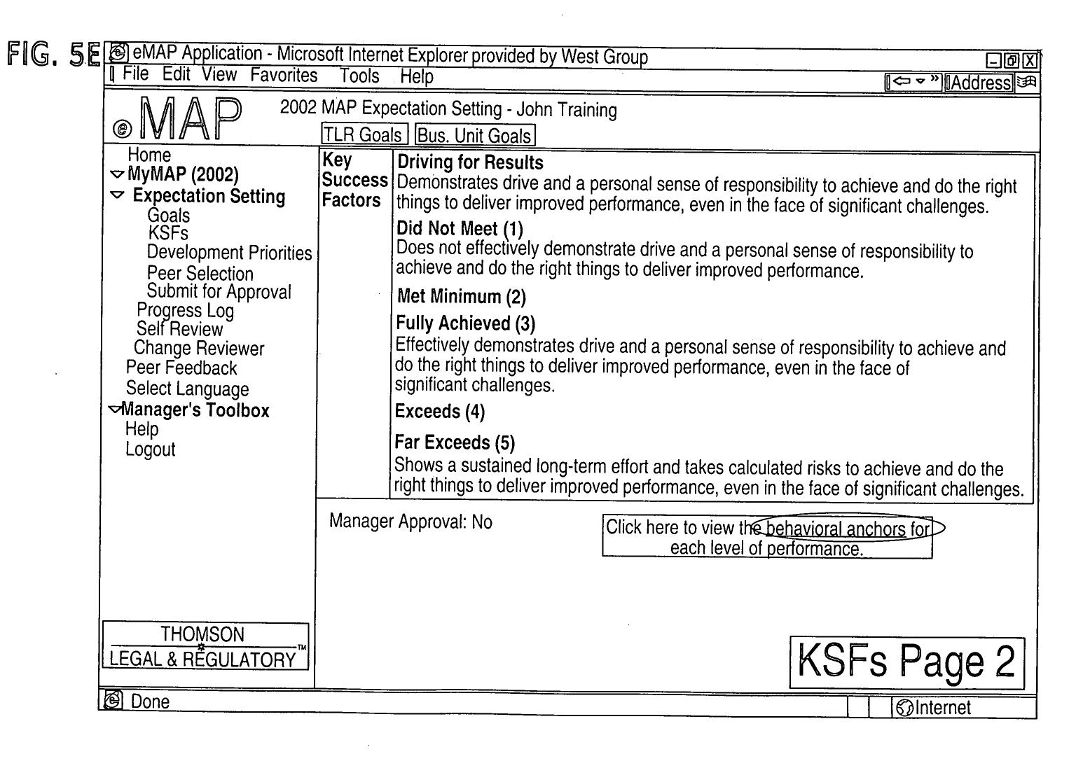

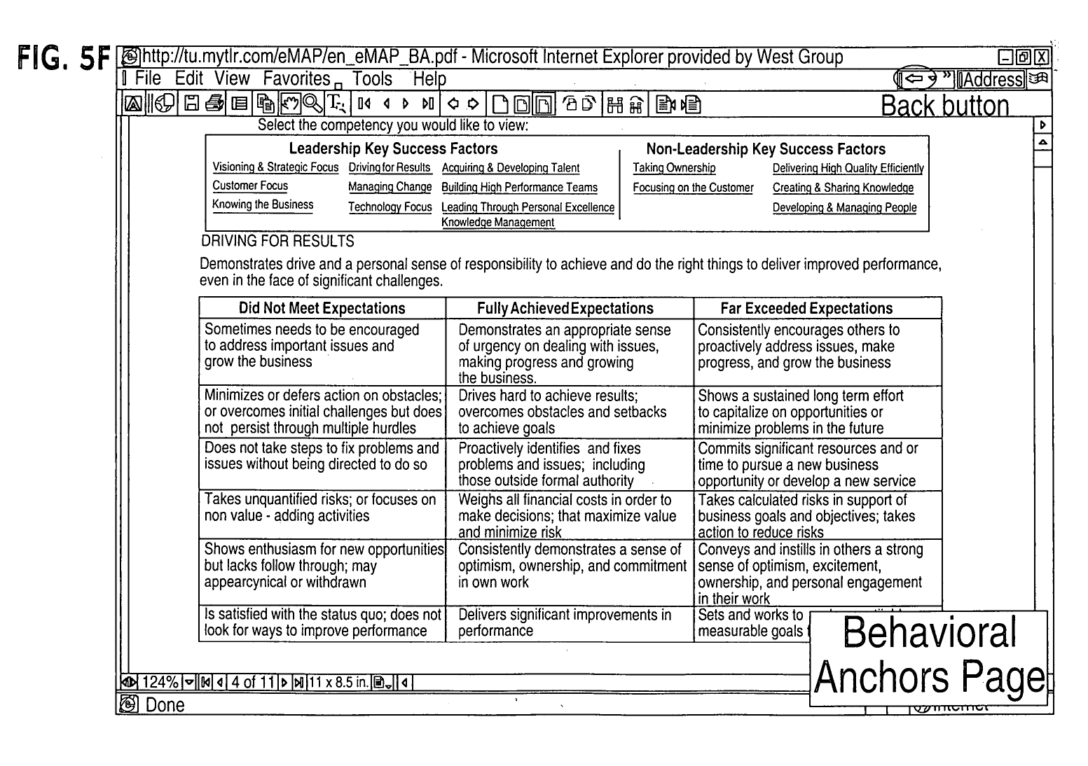

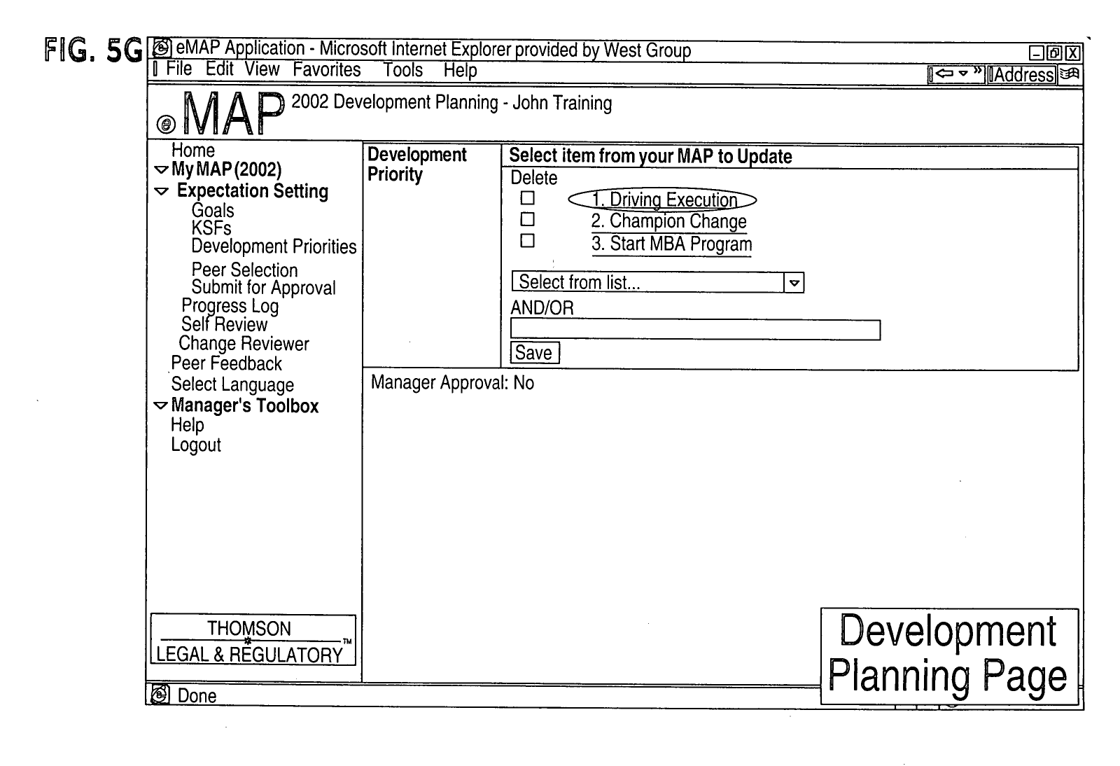

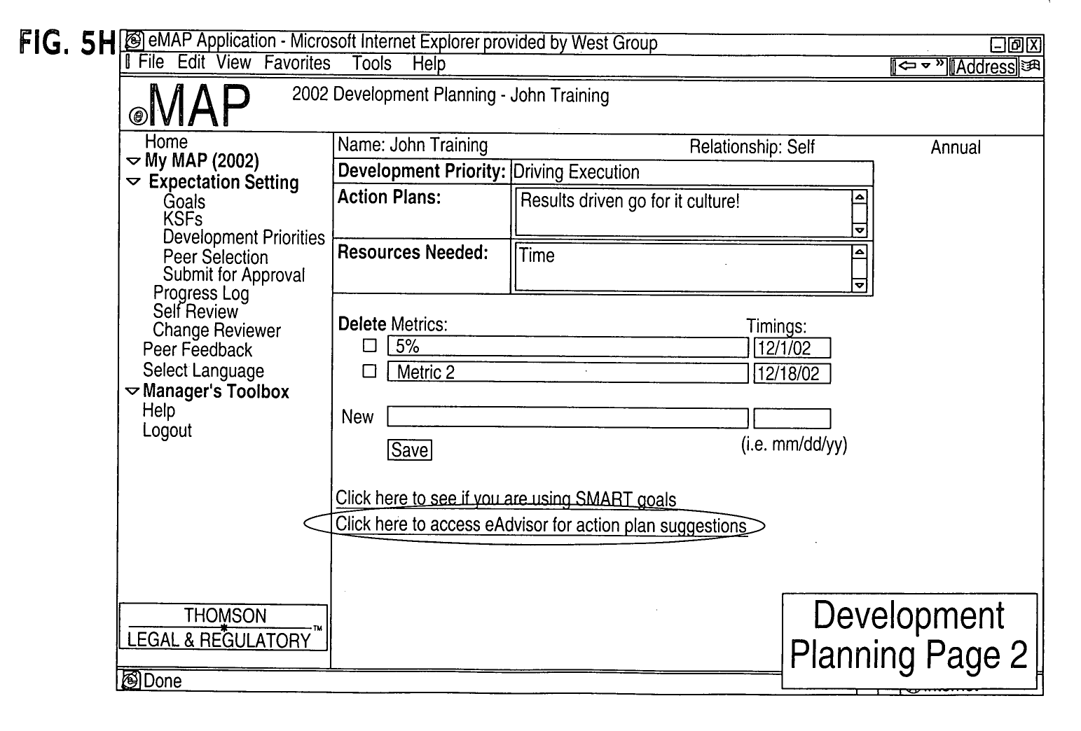

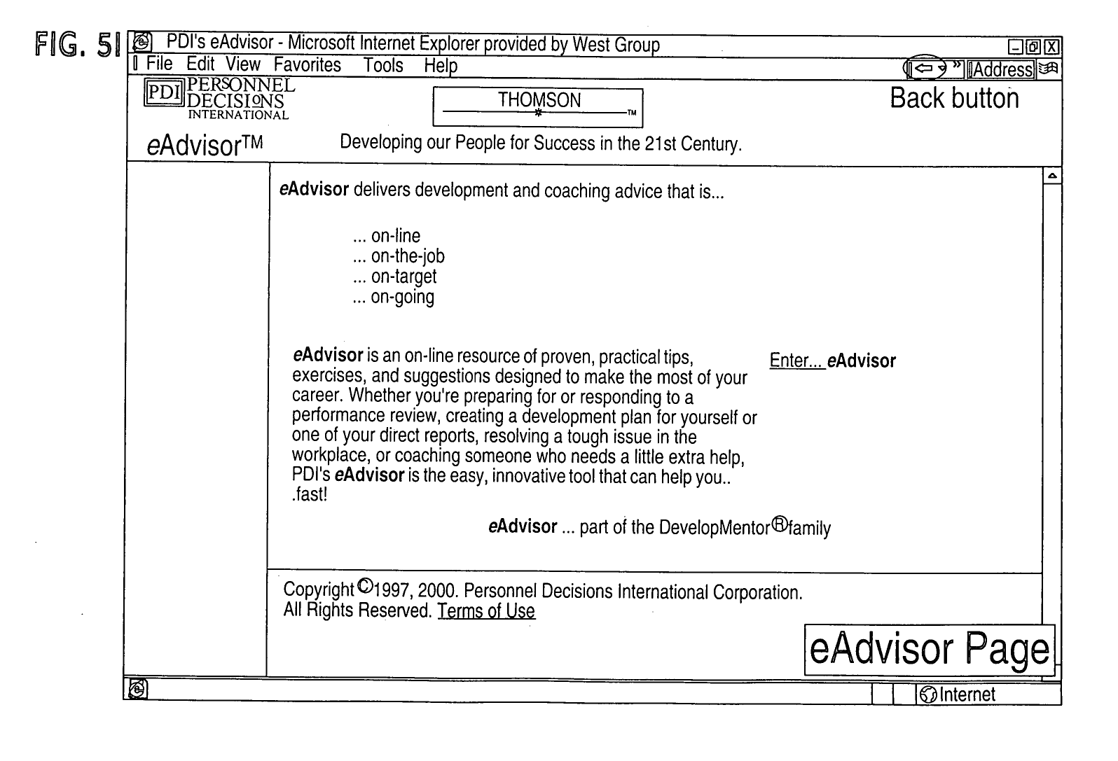

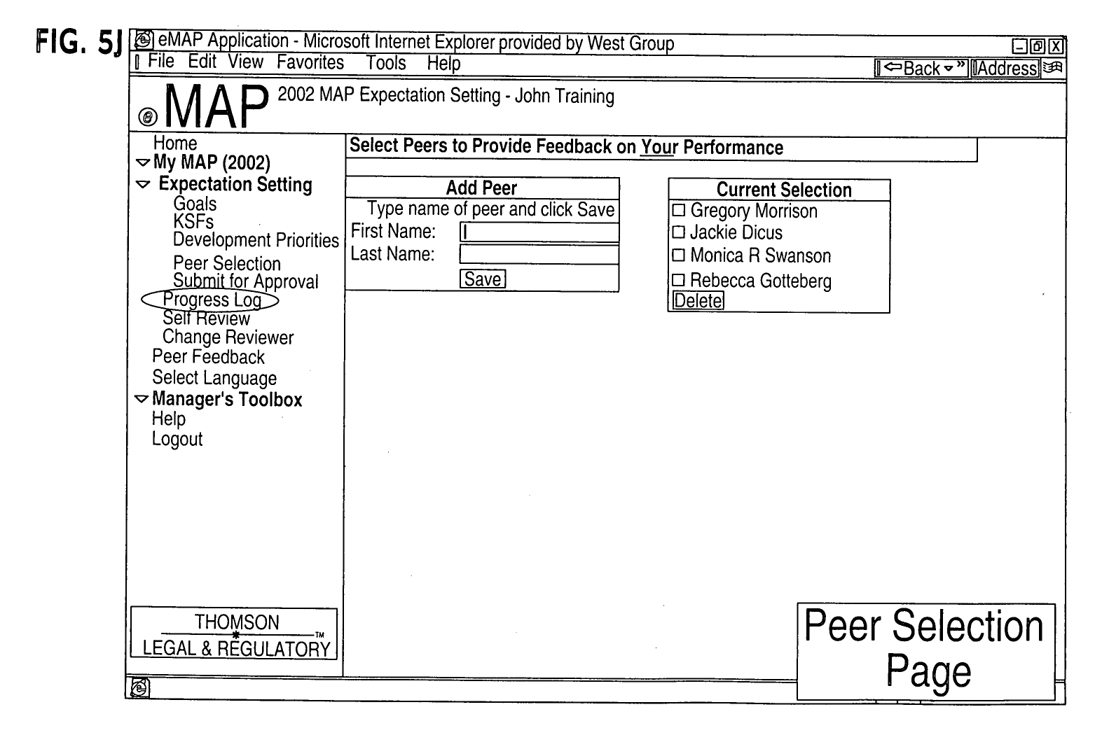

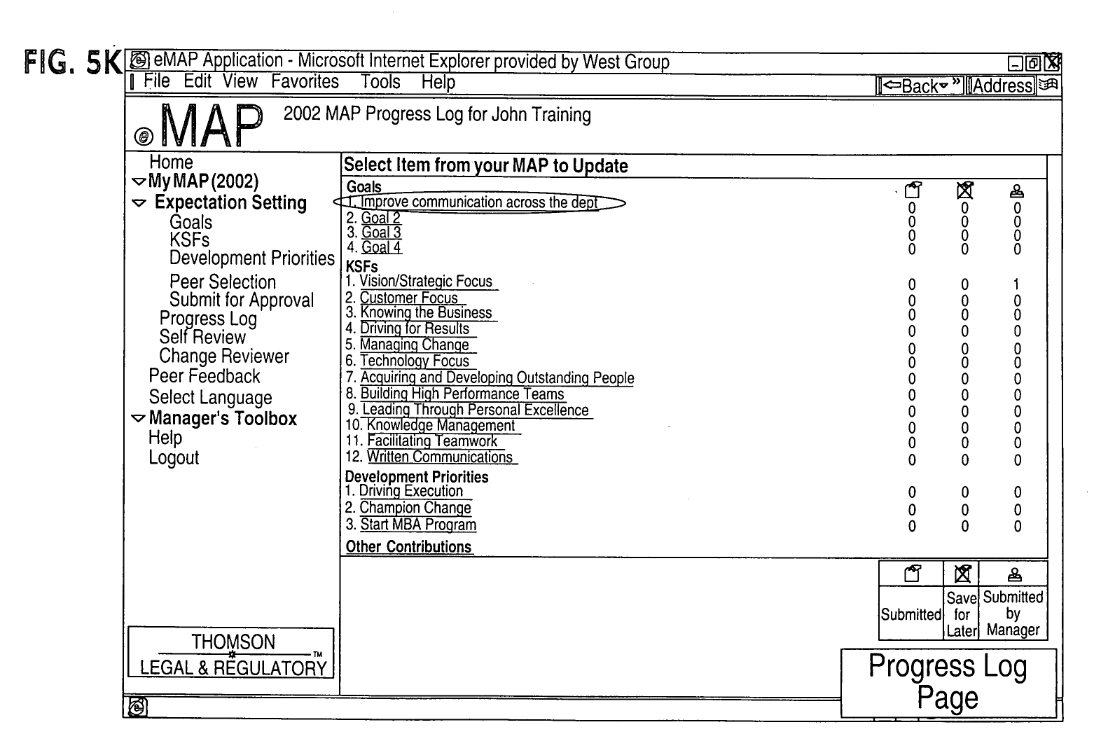

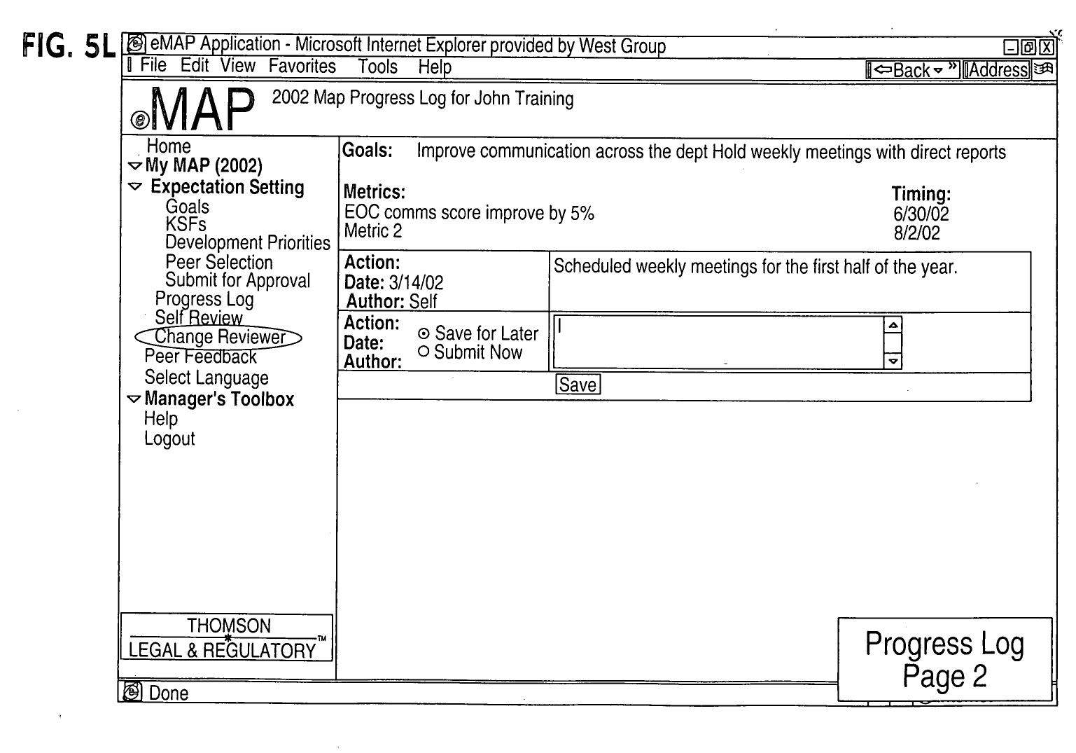

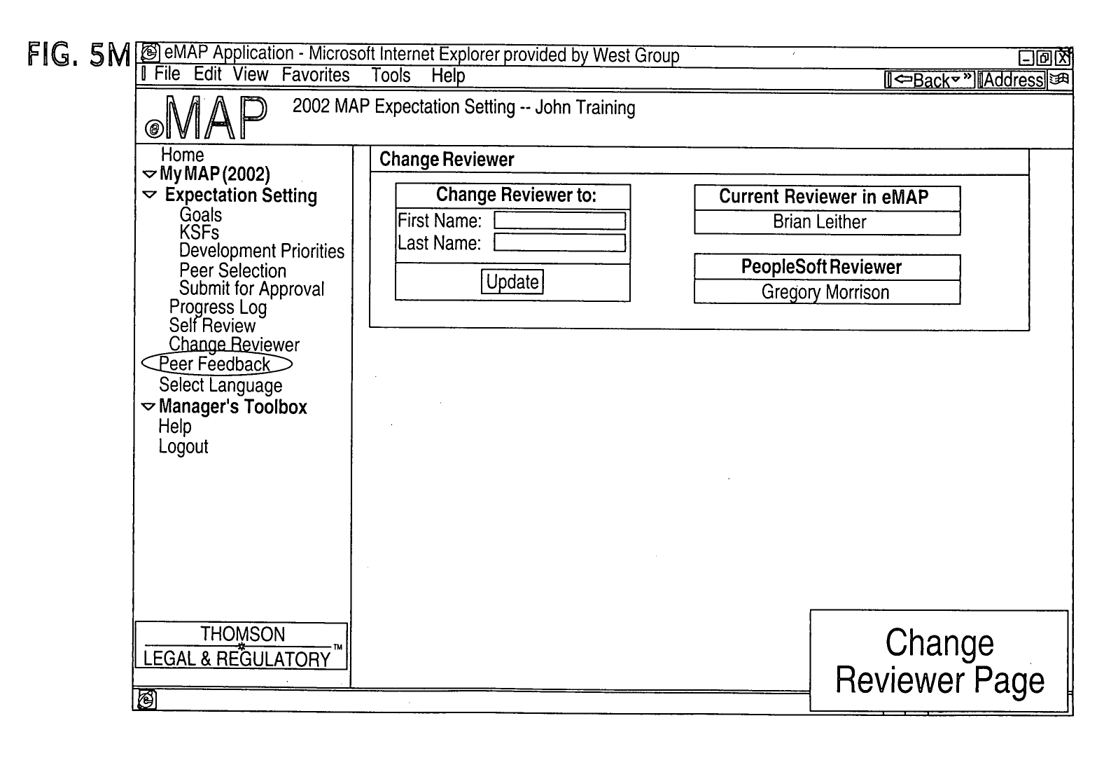

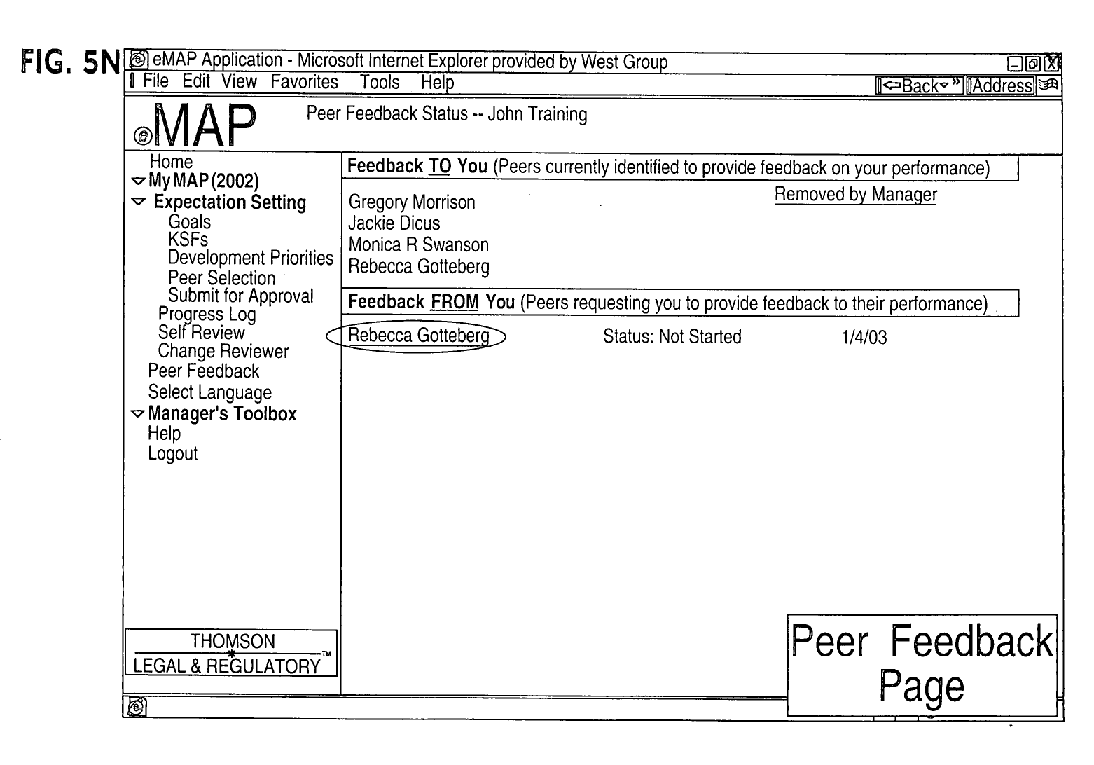

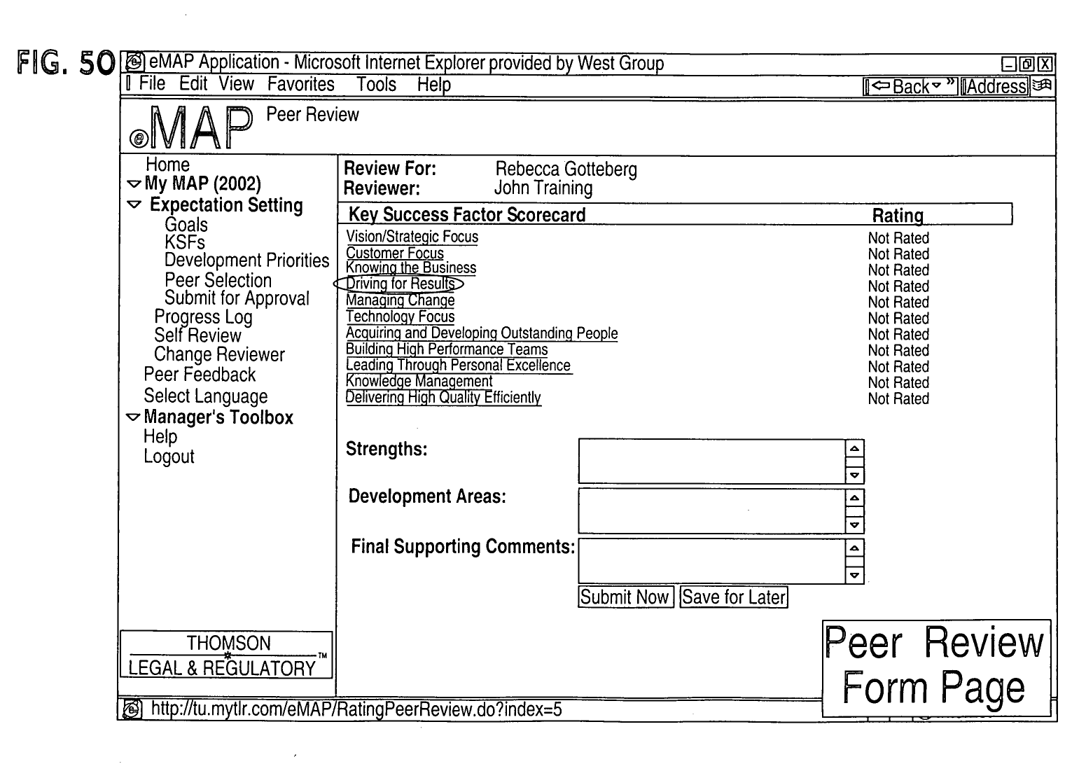

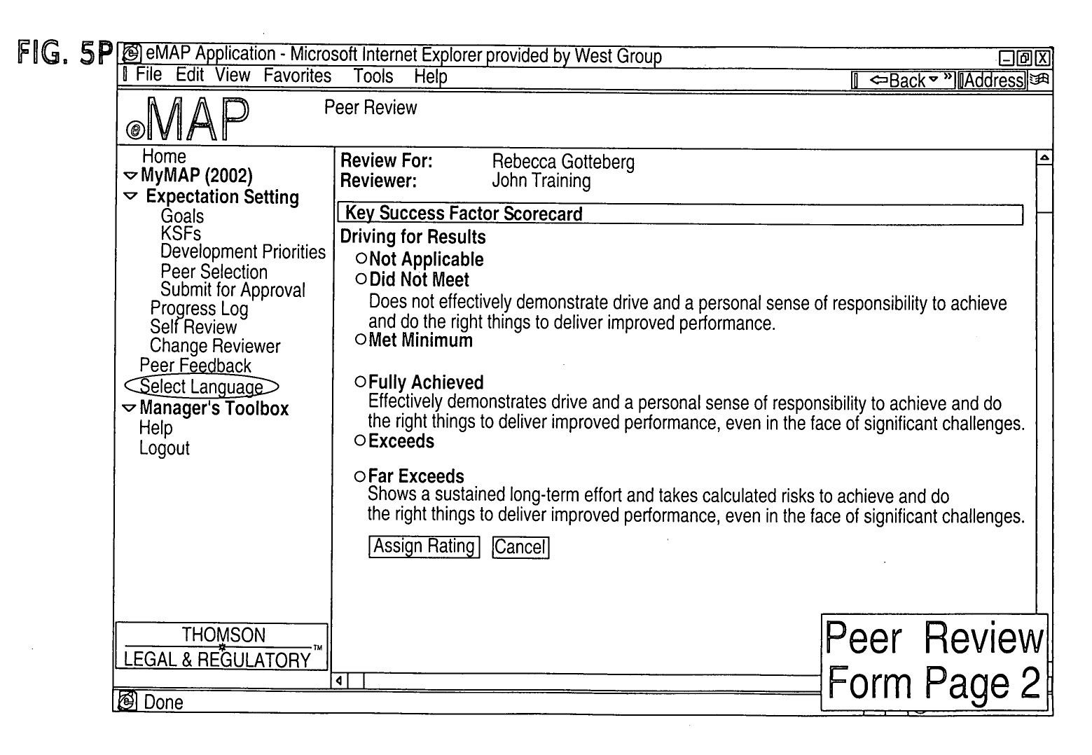

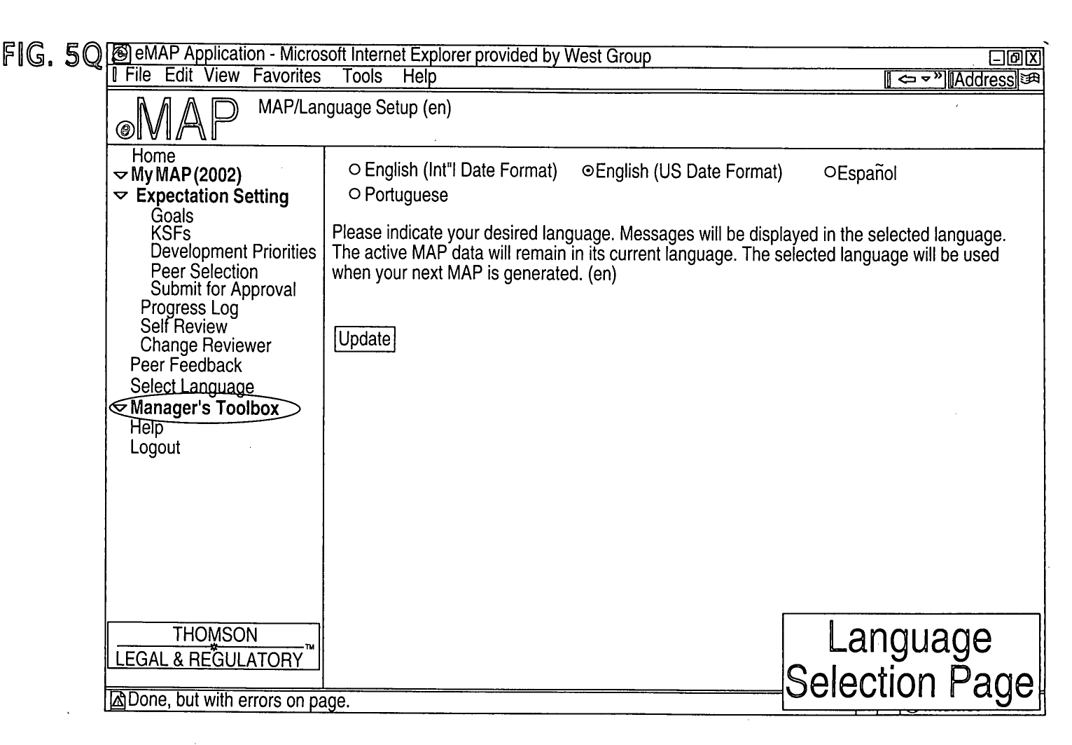

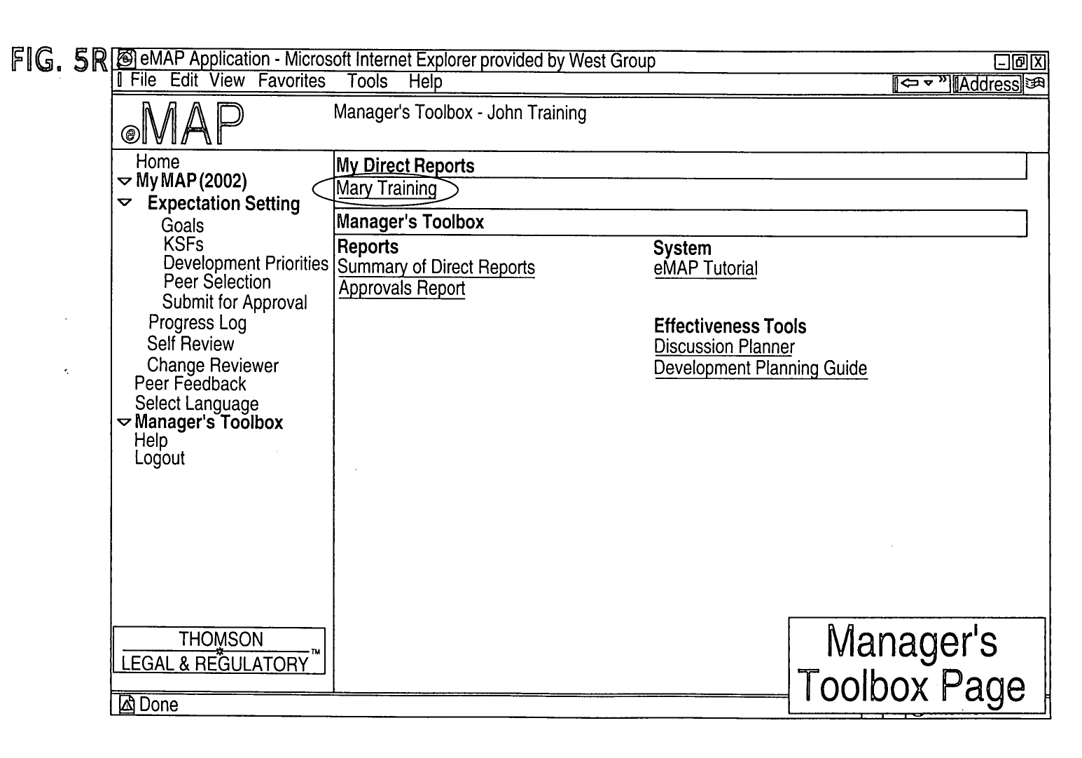

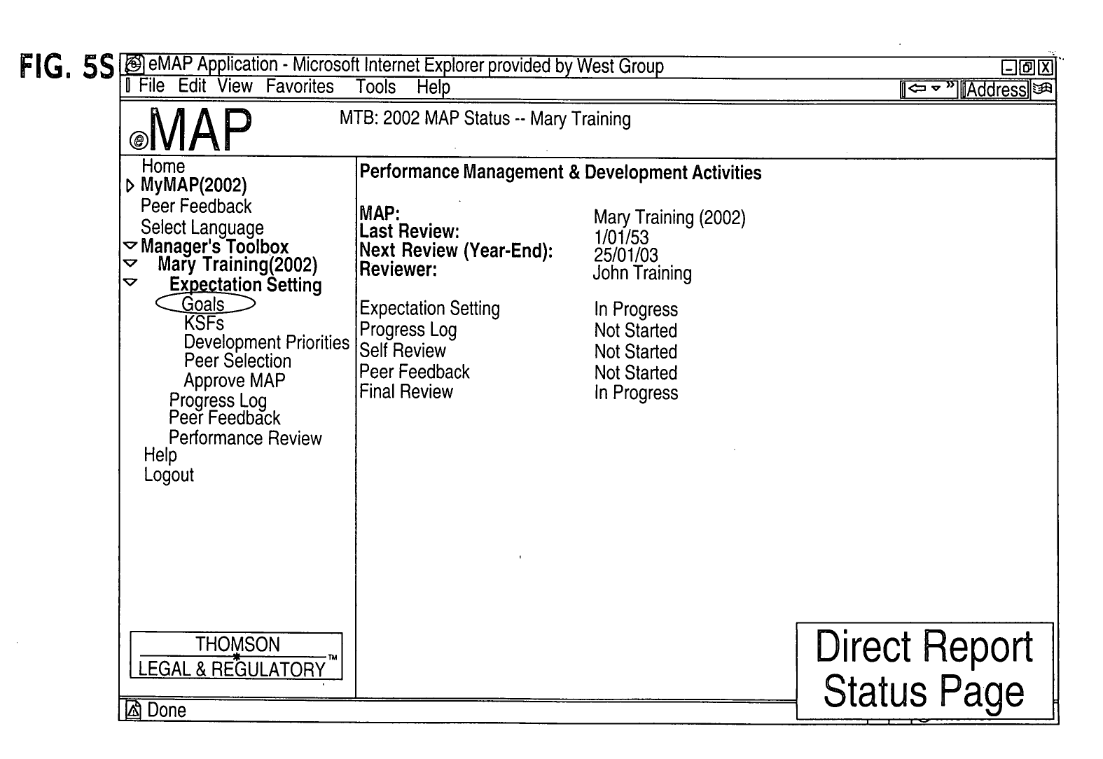

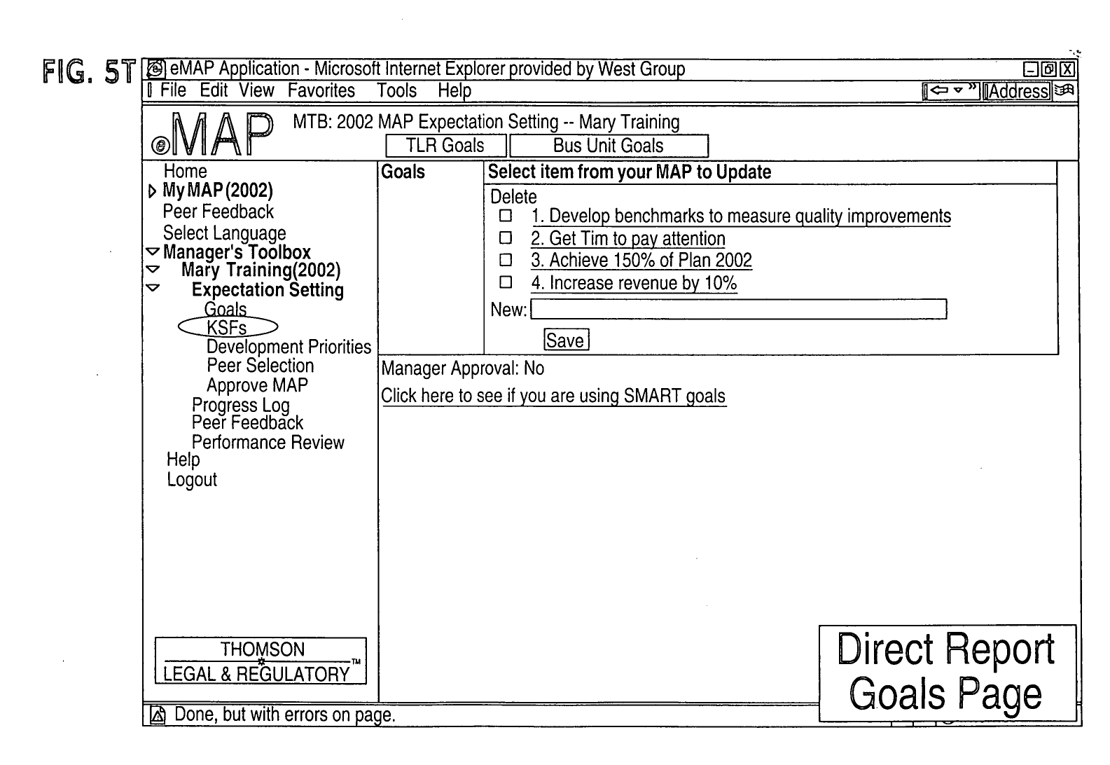

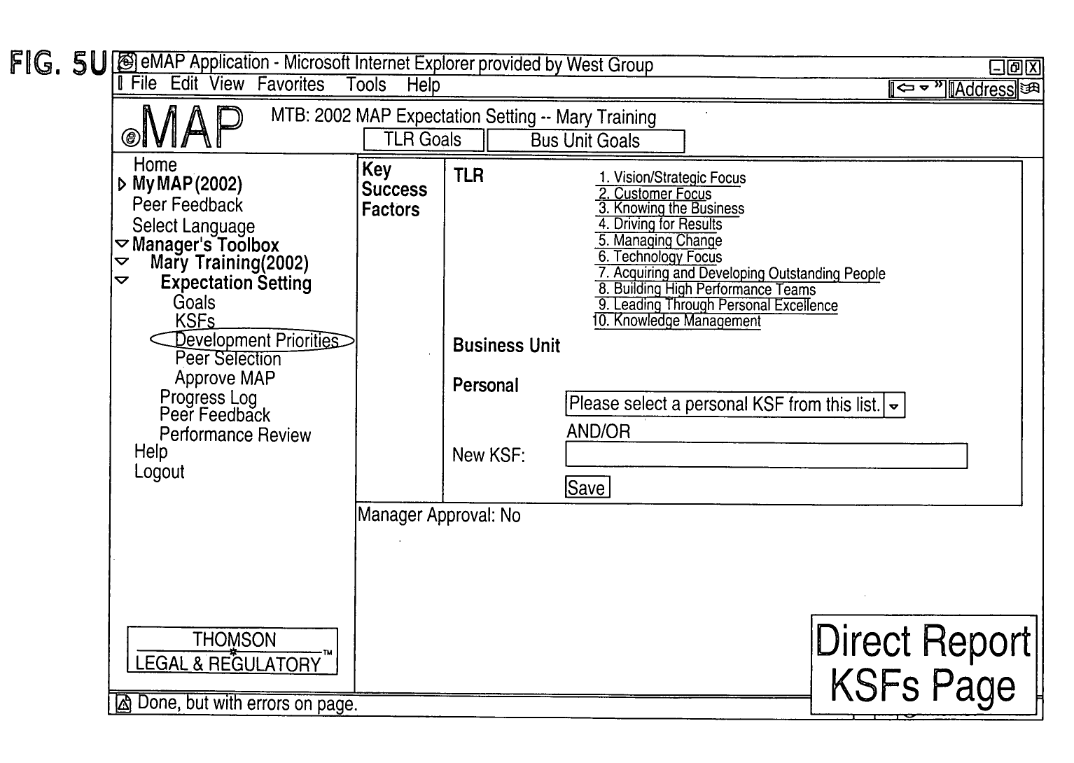

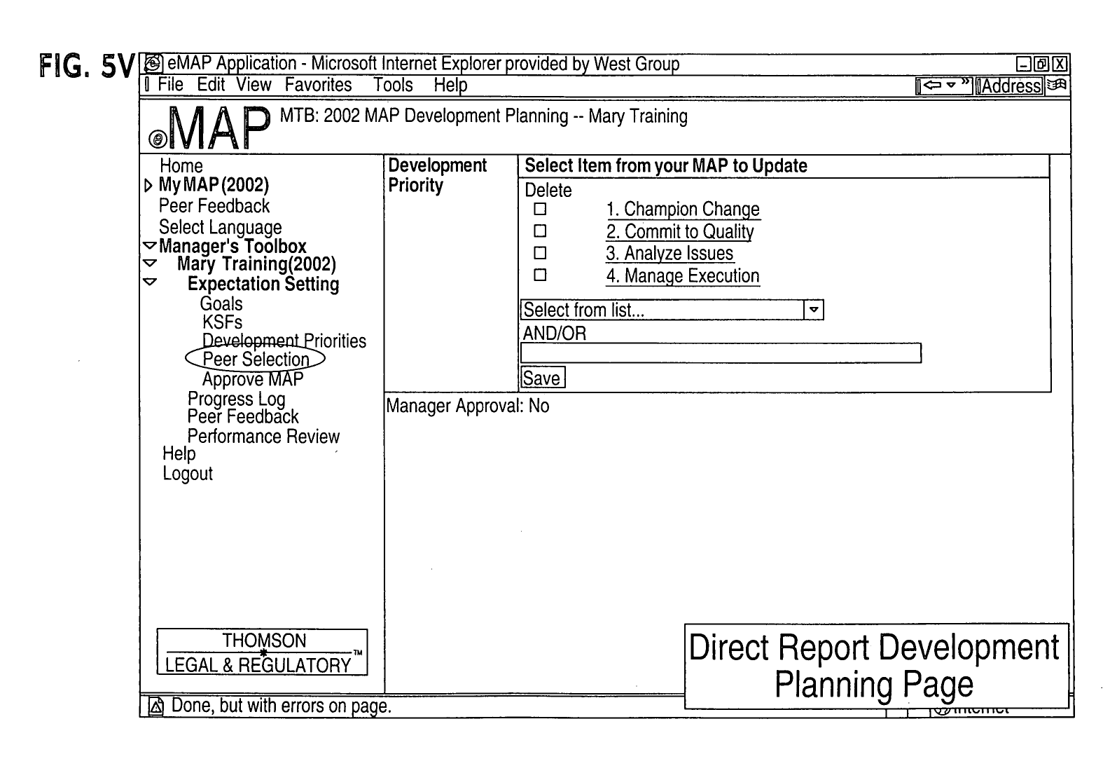

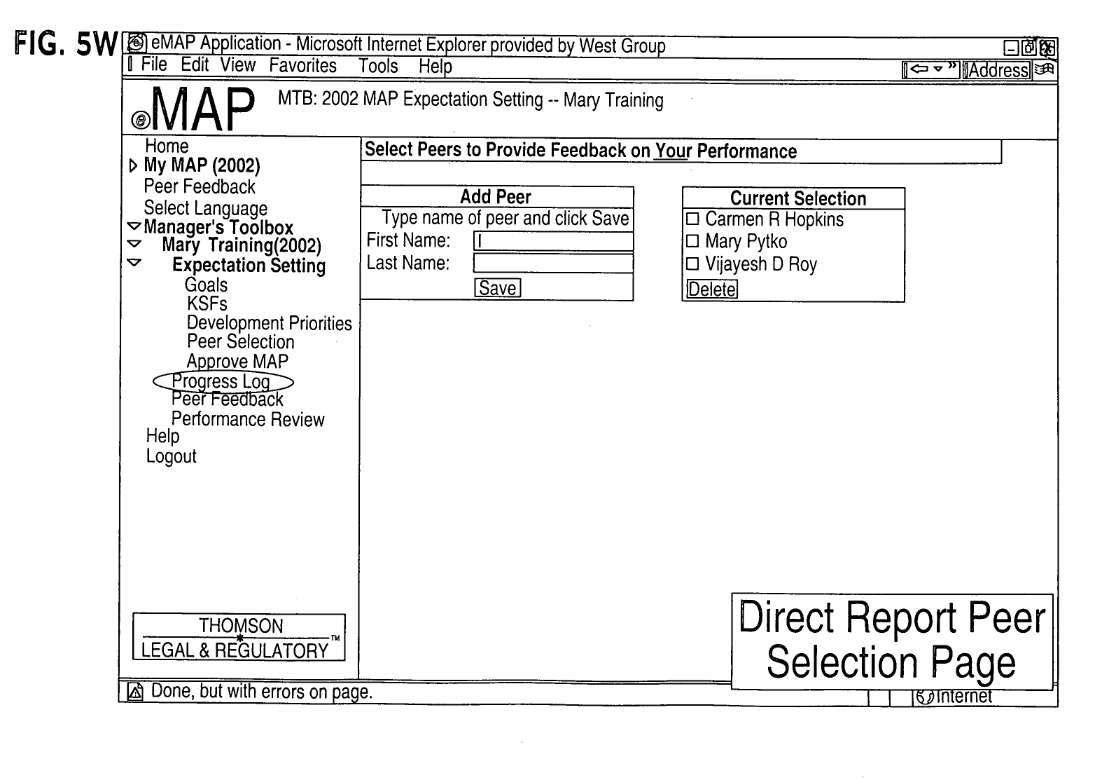

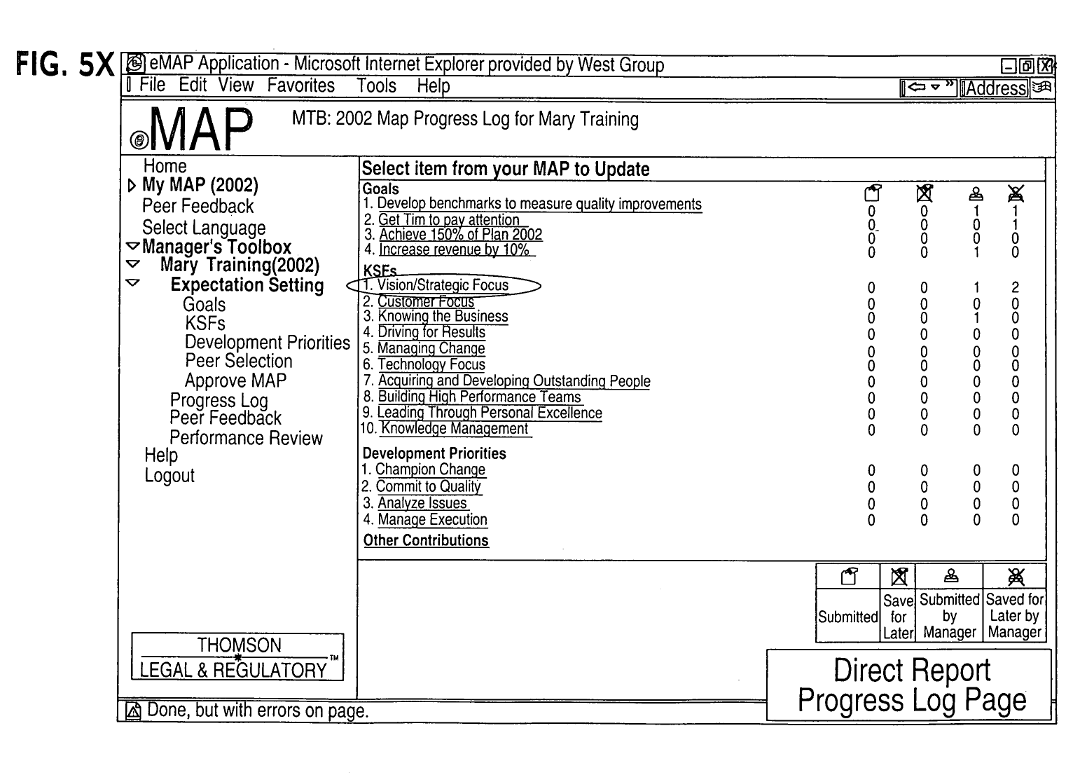

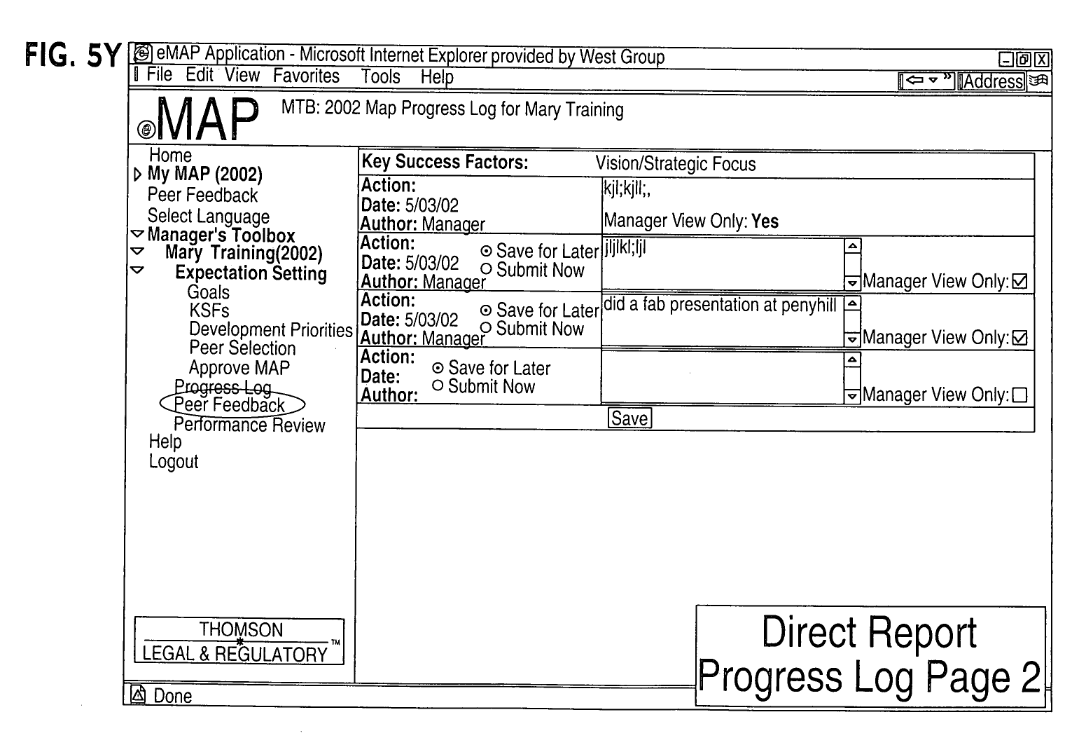

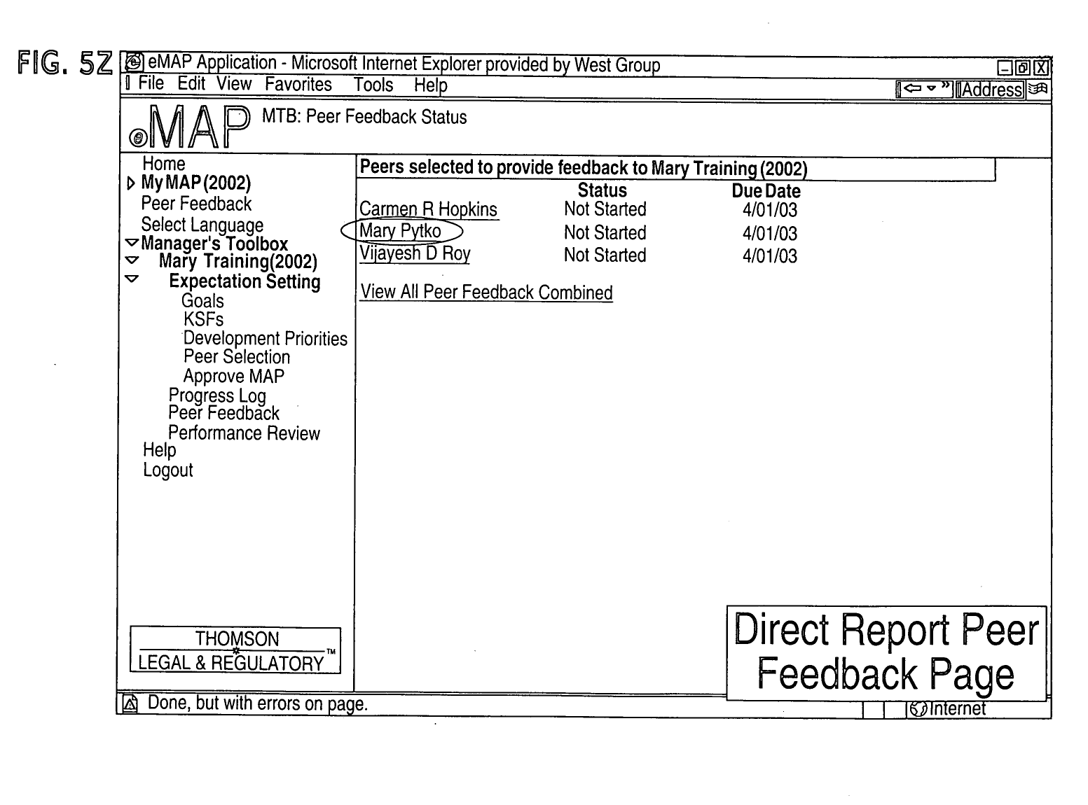

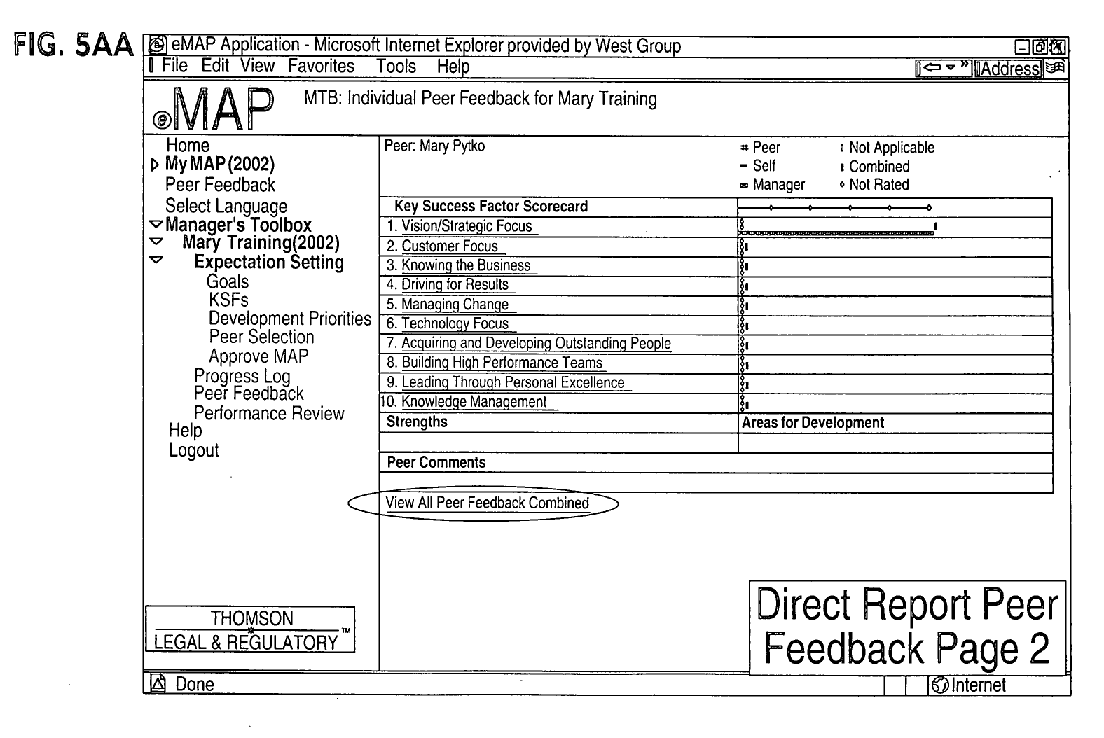

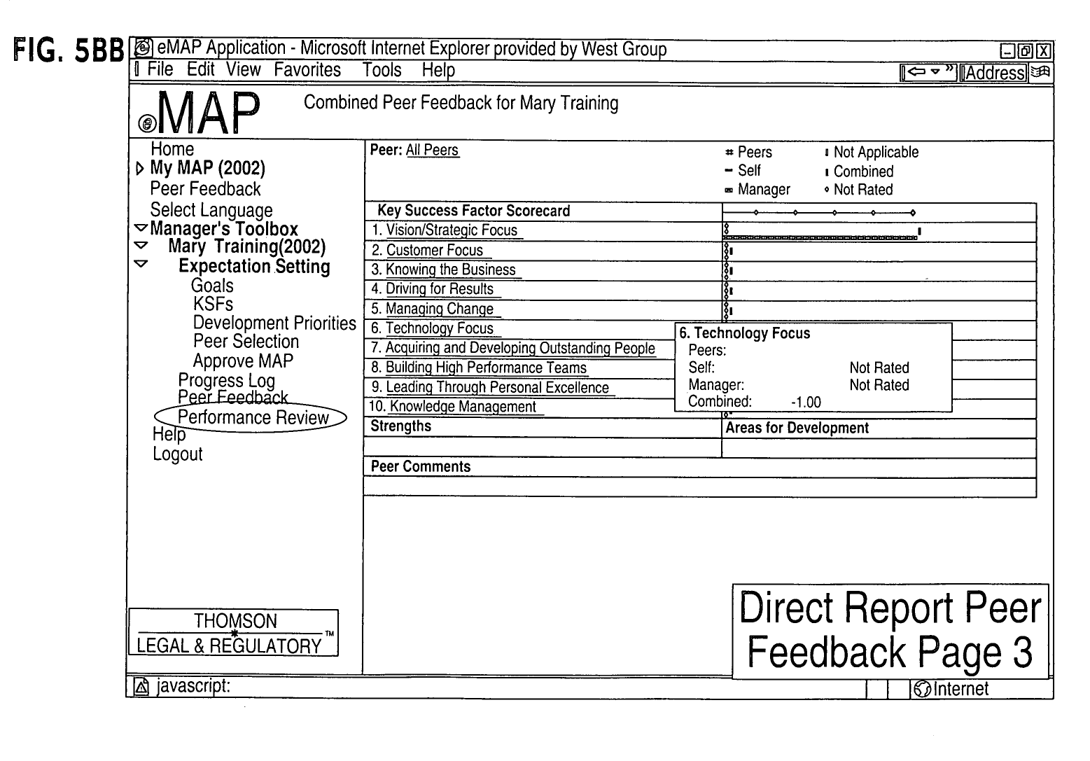

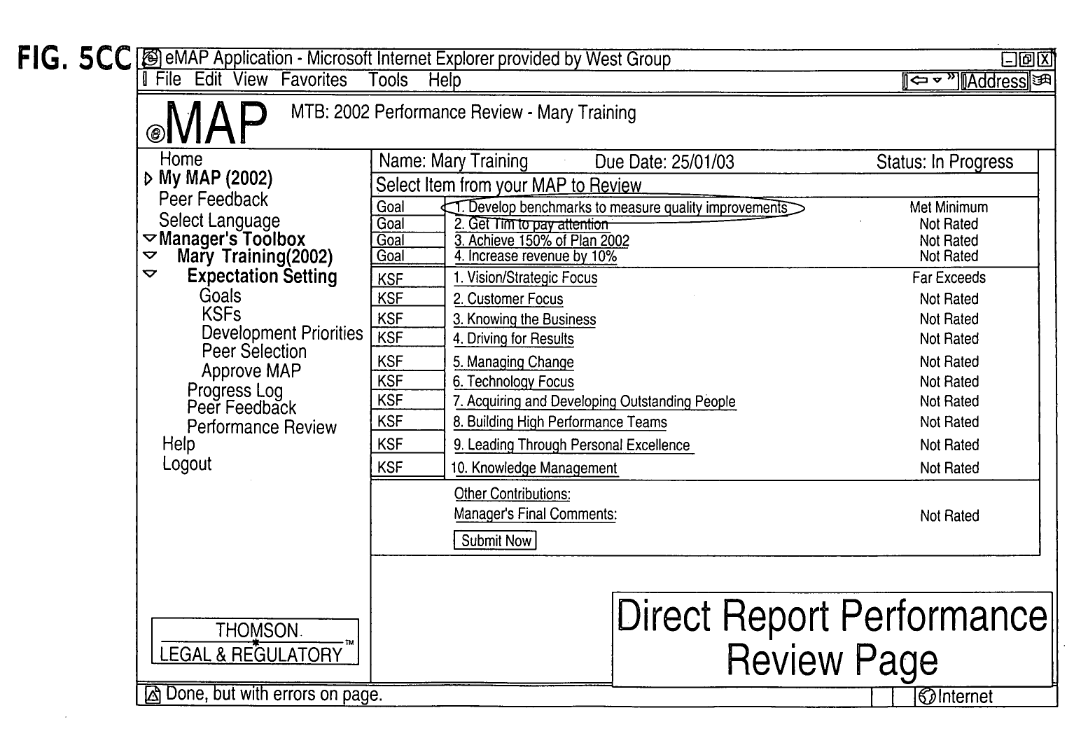

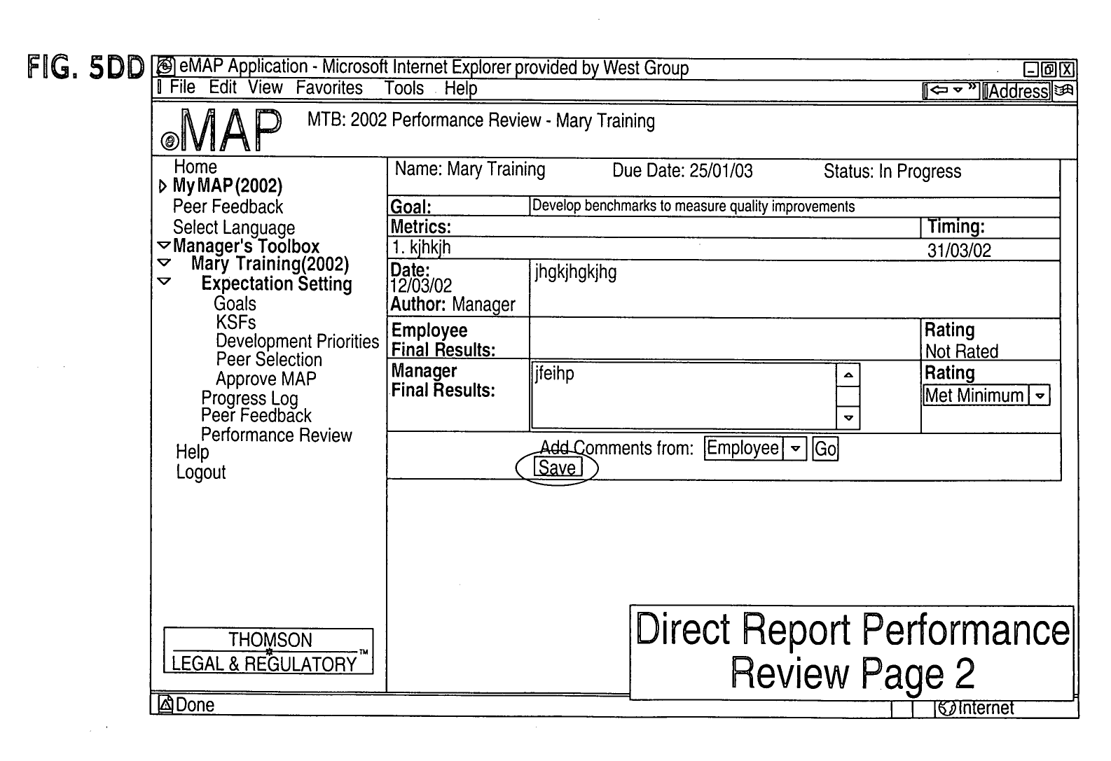

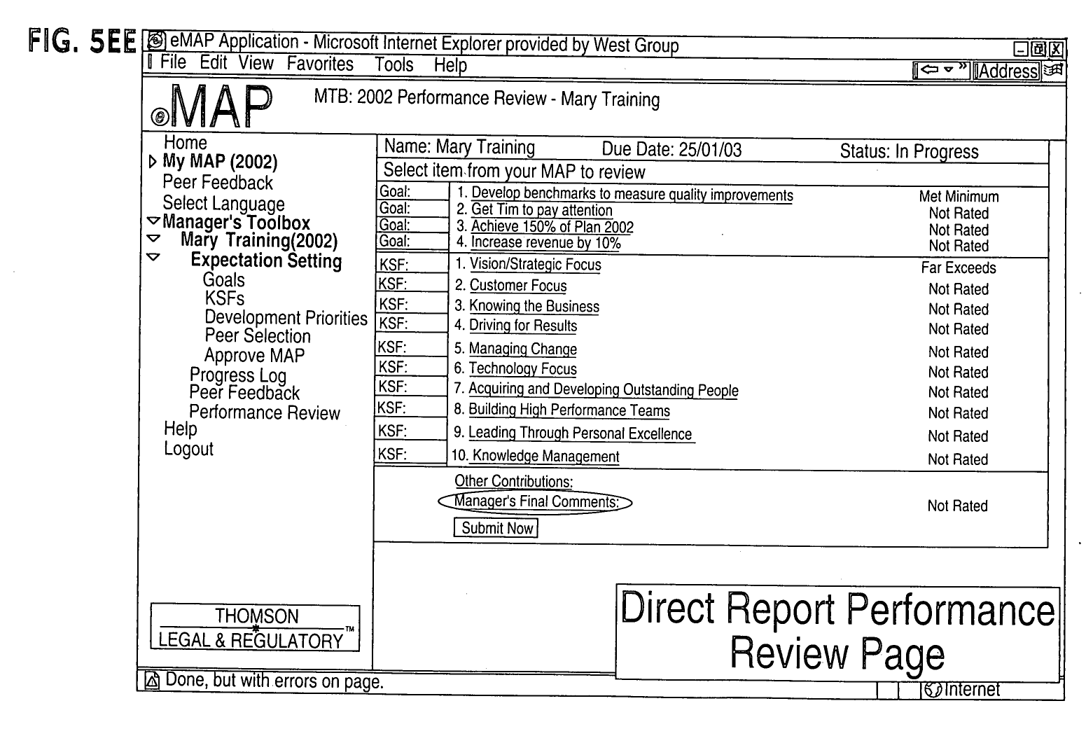

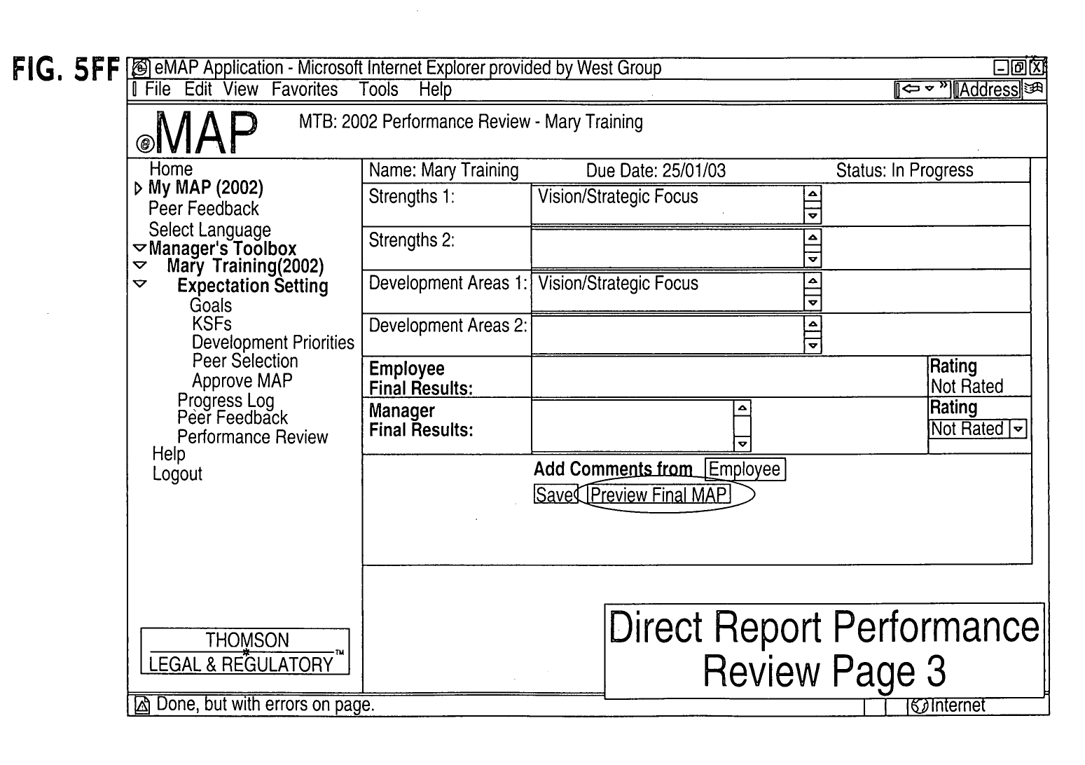

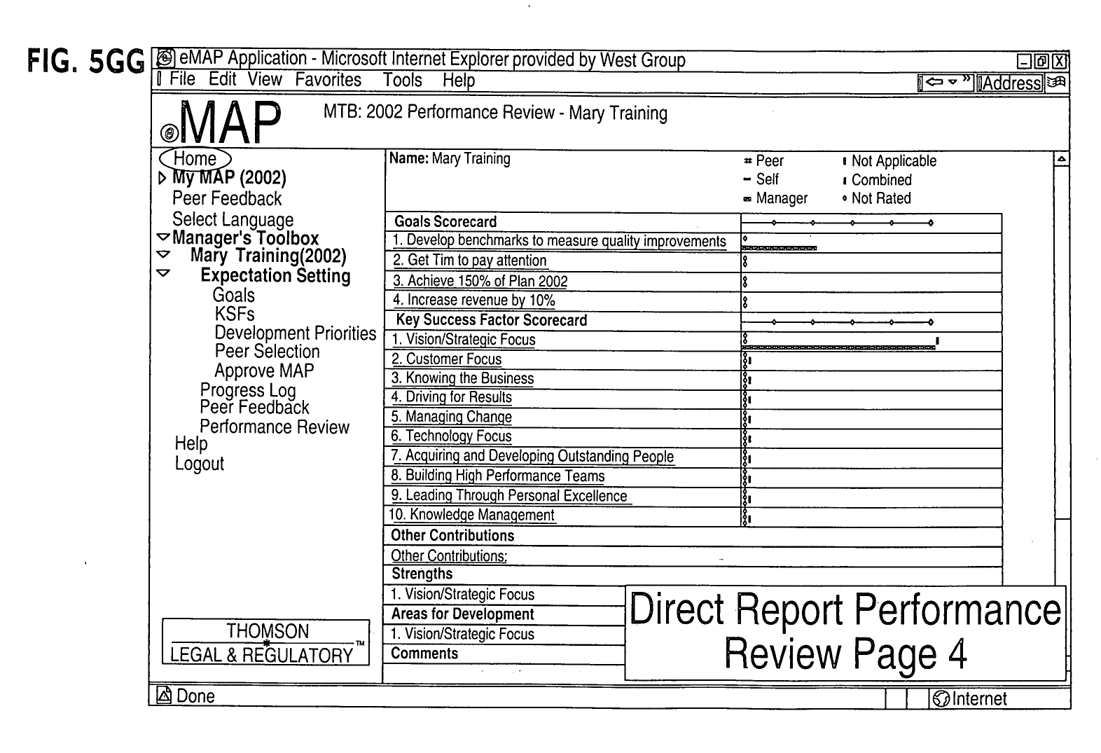

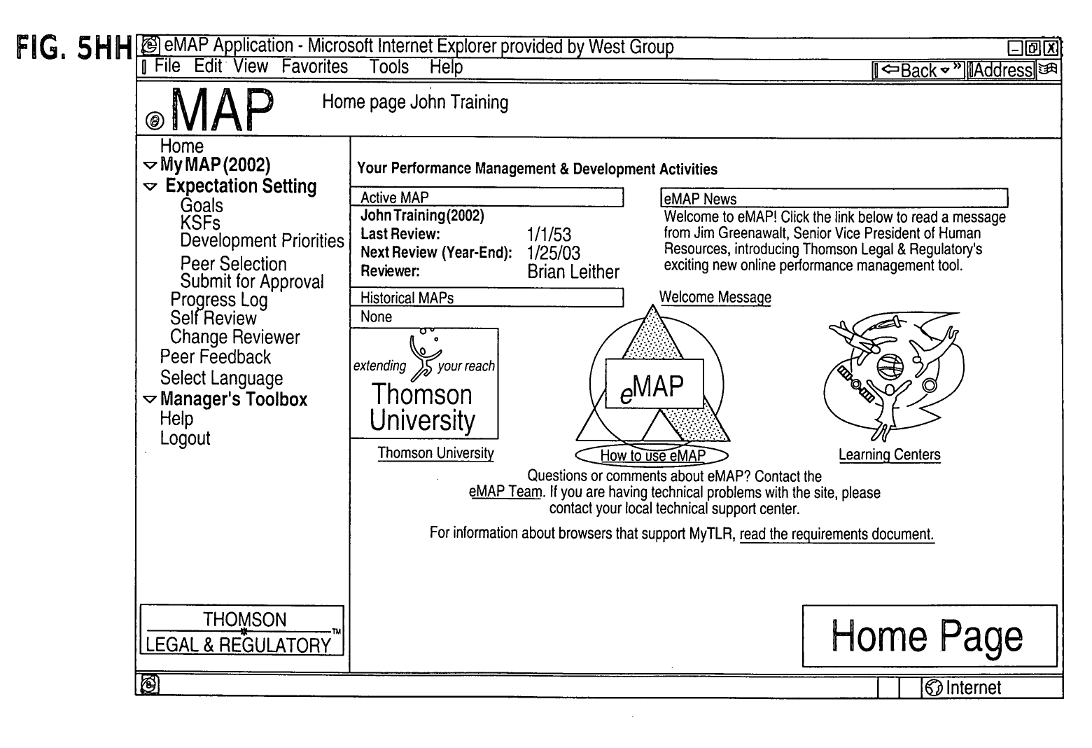

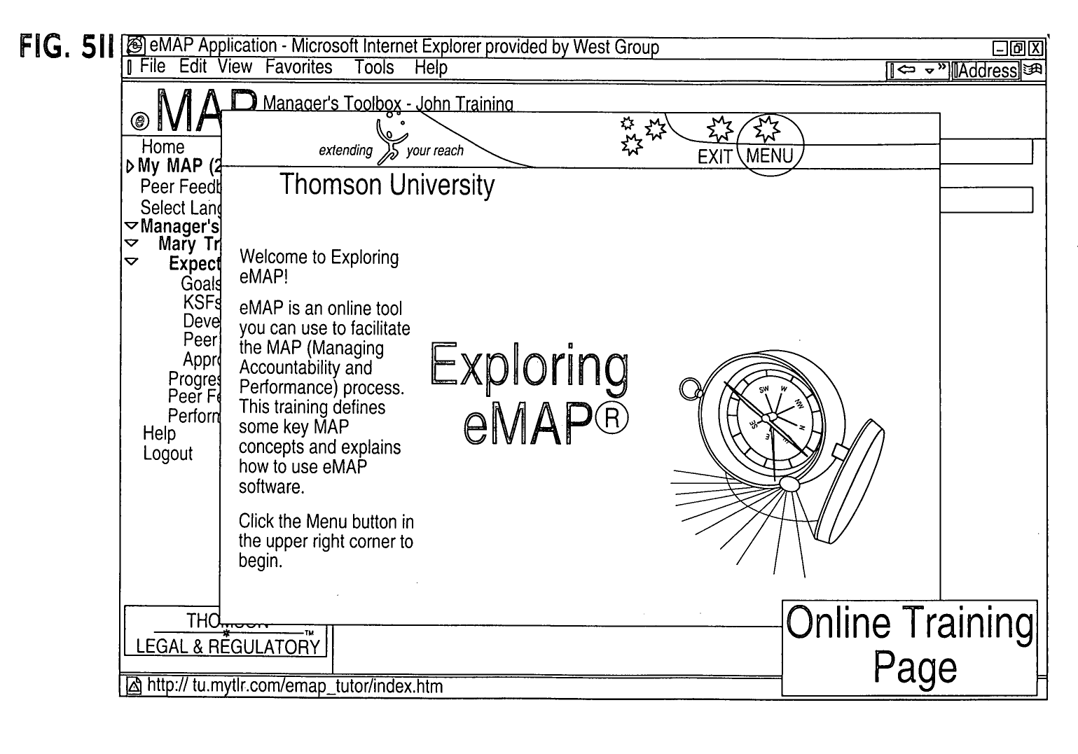

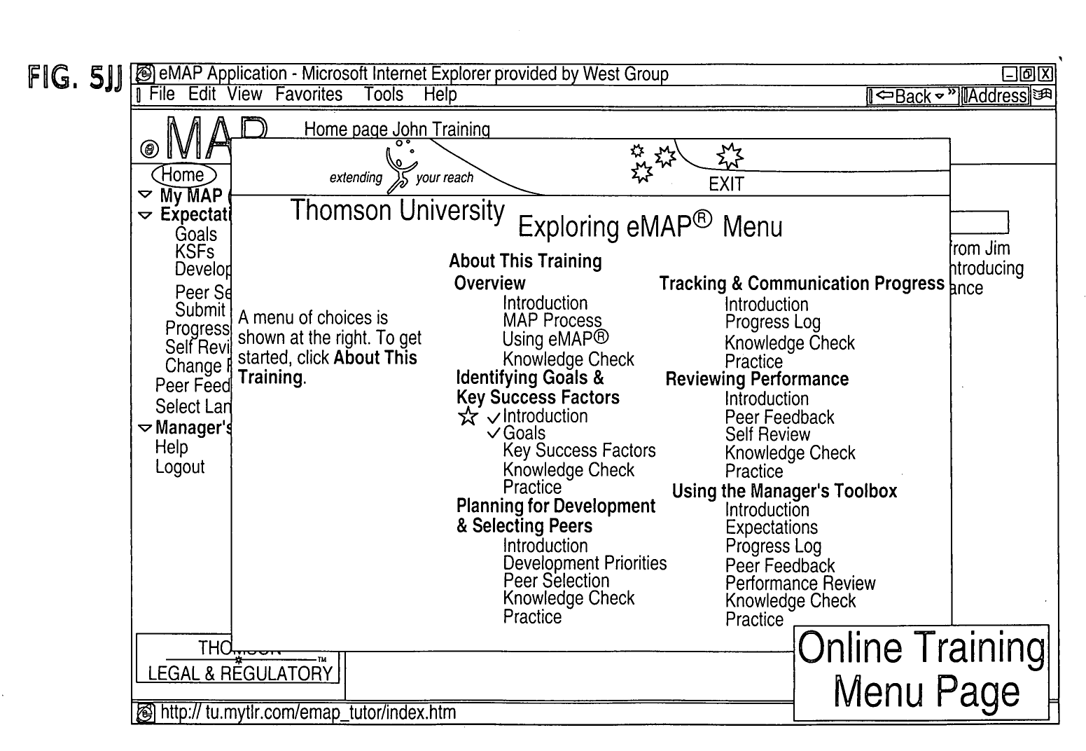

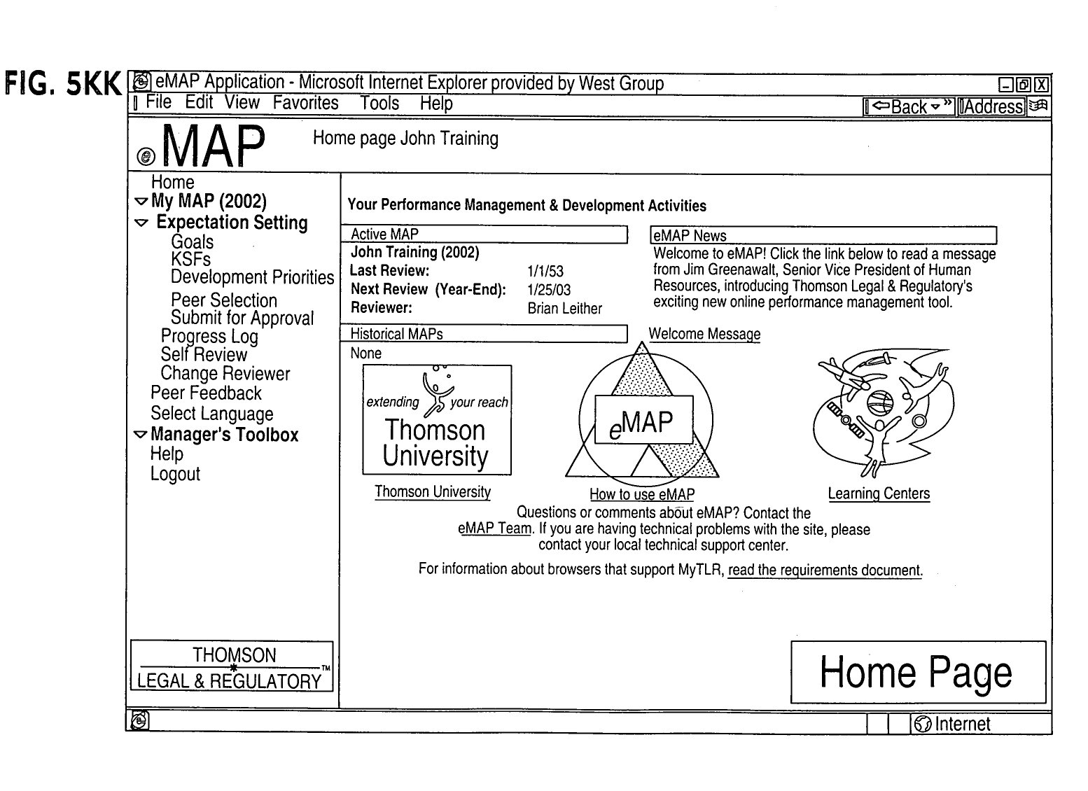

Requests for data may be implemented using calls to stored procedures located in the database. Such stored procedures extract and marshal the data and return it to calling pages. The calling page is responsible for formatting the data and displaying it on the screen as required by the functional specifications and the particulars of individual graphical user environments (See FIGS. 5A-5KK below).

Data initially populating the database may be entered via two methods. First, some data such as Key Business Objectives and Key Success Factors related to employees and tasks can be entered manually using database administration applications such as those that permit direct database and table entry which will be immediately understood by those skilled in the art. Second, some data such as employee names and manager relationships are populated via a scheduled feed from PeopleSoft databases via an LDAP architecture as shown in system 100. It is important to note that although certain data sources are shown, data can actually originate and be pulled from any other Human Resources Data processing system (e.g., payroll, benefits, etc.), enterprise resource planning system (ERP), etc. The present invention is not limited in nature and form of data source that may be used to drive management of employee accountability, performance, etc.

The aforementioned administration application may be a separate “bare bones” application not designed to be used by regular users. It allows high level access to the data and database tables to do such things as unlock records that have been mistakenly locked, pull statistical data from all areas of a company, and entering global or customized data for goals, objectives and success factors. Additionally, such an admin tool may be used to add, modify or delete users, drive reporting functions, etc.

With greater particularity to FIG. 1, depicted therein is a diagram of a system for managing employee accountability and performance in accordance with an embodiment of the present invention. In particular, a user system 102 such as one incorporating a World Wide Web browser (e.g., Microsoft Internet Explorer, etc.) may access a network connection to reach applications for facilitating employee accountability and performance data. Such access may be made through a network such as the internet, via a firewall 104, a front-end security system 106, and application server 108 and ultimately an application server 108.

Application server 108 is configured to permit and manage employee related data including employee accountability and performance data in accordance with the present invention. Application server 108 interacts with the database system and server 110 to facilitate storage and retrieval of such data. Application server 108 also maintains application data which may be presented back to user system 102 via web type screens and corresponding web pages. The underlined applications driving the facilities of application server 108, may be provided by individual server systems such as Execu-Track server 114 (made and marketed by HR SOFT), e-Advisor server 116 (made and marketed by Personnel Decisions International, Inc.) (used for providing instructional data on the establishment and management of performance data), SAP (SAP) Server 118 as well as others that may be added or otherwise included in the future as indicated by the ellipses as shown in FIG. 1. The present invention is not limited to these particular servers or business applications, but actually may be coupled to any particular business applications within an organization. Execu-Track, e-Advisor, and SAP are trademarks and/or registered trademarks of their respective rights owners.

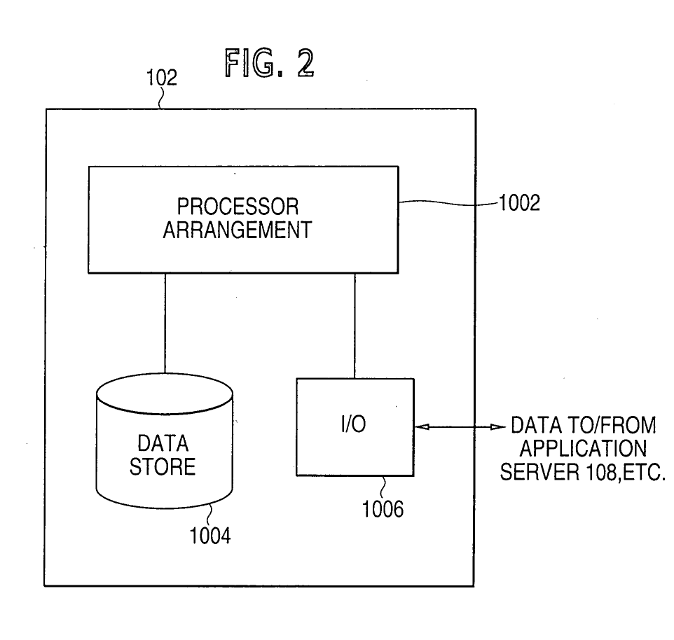

Referring now to FIG. 2, depicted therein is a block diagram of user system 102. In particular, user system 102 includes a processor arrangement 1002 which is coupled to a data store 1004 and I/O facilities 1006. User system 102 is configured to facilitate data transfer to and from application server 108, etc. Such data communications may be carried out via any modern communications facility such direct network connection, wireless network connections, etc.

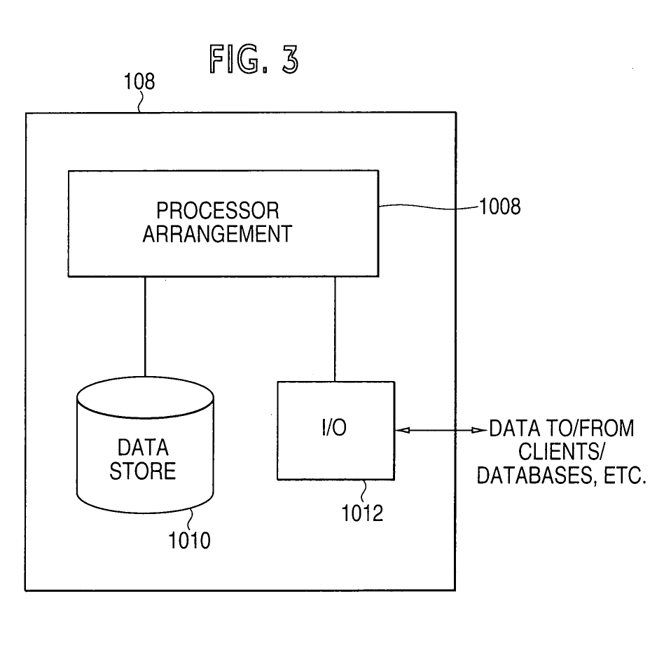

Referring now to FIG. 3, depicted therein is a block diagram of application server 10. In particular, application server 108 includes processor arrangement 1008, data store 1010 for storing application server information and data in accordance with the present invention, and I/O facilities 1012. I/O facilities 1012 of application server 108 are configured to communicate data to and from user system 102, database server 110, etc.

The data processing systems shown in FIGS. 2 and 3 are merely exemplary and many other data processing systems may be used which incorporate multiple processors, distributed and non-distributed database management systems and data stores, etc. Such other data processing system configurations certainly are covered by the spirit and scope of the present invention.

### Operational Aspects of the Present Invention

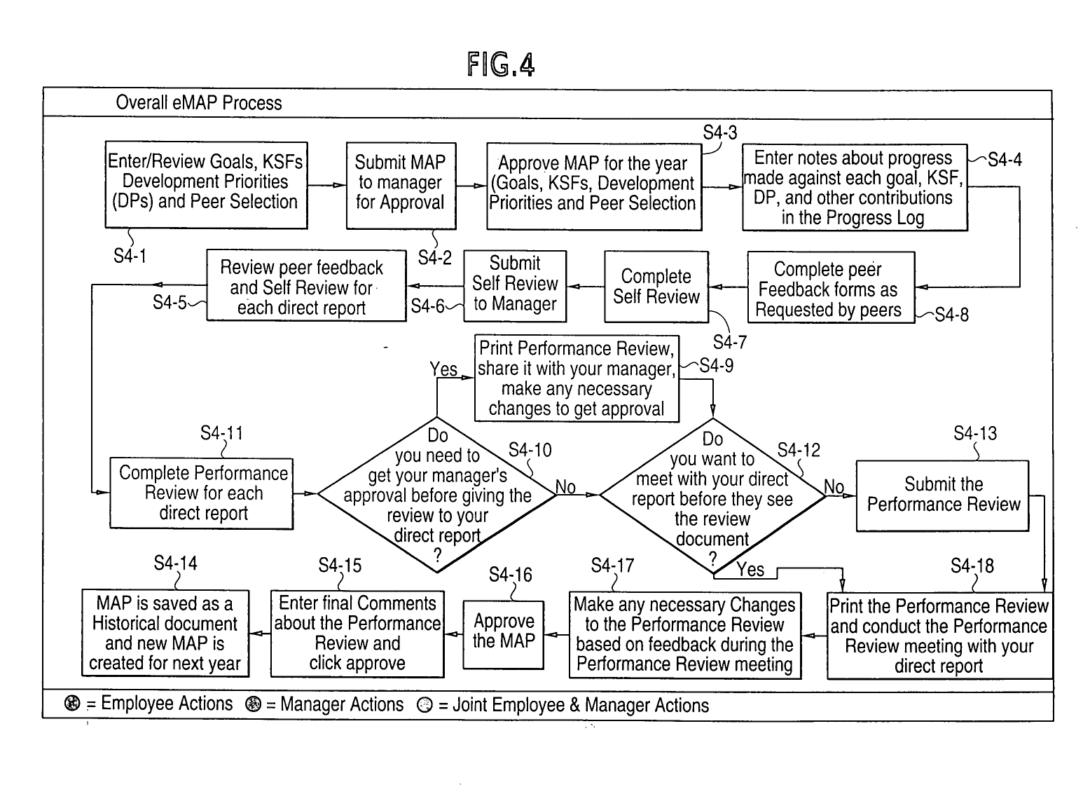

The structures depicted in FIGS. 1-3 are designed to operate together to facilitate systems and methods for managing employee accountability and performance data within an organization. As a result, to facilitate the operational aspects of the present invention software and related systems have been developed to permit users and managers within an organization to create and manage tracking data to manage performance and accountability related to employees and job and task performance. The creation of such data and management of the same is referred to herein as a “MAP” which stands for managing accountability and performance data related to an employee within an organization. The overall processes implemented by the present invention are depicted in FIG. 4 to which reference is next made. Detailed implementation specifications facilitating the overall processes shown in FIG. 4, are shown in and described below with regard to FIGS. 5A-5KK.

Referring now to FIG. 4, at step S4-1, employees within an organization and managers will enter and review project and job goals, key success factors (KSF) (those factors that define job/task success such as time to task completion, management reporting, etc.), employee developmental priorities (e.g., things an employee must do to realize advancement, etc.) and peer selection requirements related to particular tasks and projects to be carried out within an organization. Such data entry and review produces a MAP to be managed within system 100 (FIG. 1).

Next, at step S4-2, the MAP is submitted to at least one manager for appropriate approvals. In particular, an employee's objectives for performance will be created and corresponding data will be stored in database server 110 (FIG. 1).

Next, at step S4-3, the MAP will be approved for a particular period of time such as a year, etc.

Next, at step S4-4, managers and employees will enter notes about progress made against each goal, key success factor, development priority and other contributions in a progress log related to a particularly established MAP. Such data will be stored and managed within database server 110 (FIG. 1)

Next, at step S4-8, employees will complete peer feedback forms online as requested by peers within a particular MAP definition as established during step S4-1 and possibly throughout the entire evaluation process. Data regarding such online forms will be stored within database server 110 (FIG. 1).

Next, at step S4-7, an employee will complete a self review form online relative to his own particular performance objectives and enter data to be stored within system 100 and in particular within database server 110 (FIG. 1). Such self-review data (along with all other performance and accountability data) may be added, modified, deleted throughout a review period in great contrast to prior annual review like review systems. Now, employees and managers can gain accurate snap-shots of employee performance within any particular review period simply by accessing graphical user interfaces like or similar to the type depicted in FIGS. 5A-5KK as discussed below.

Next, at step S4-6, an employee will submit his self review online forms via appropriate processing online to a manager for review. The manager will enter the applications provided by application server 108 (FIG. 1) in the same way a user accesses the same. In the case of a manger (or someone with different access rights than an employee), access to the applications within application server 108 and database server 110 (FIG. 1) are governed by an applicable security scheme tracked within application server 106, etc. within system 100 (FIG. 1).

Next, at step S4-5, a manager will review peer feedback and self review forms online for each of his/her direct reports that reports to that particular manager.

Next, at step S4-11, a manager will complete online performance reviews for each direct report.

Next, at step S4-10, a determination will be made (with employee input) as to whether a manager's approval is required before giving a review to a direct report. If such approval is required, processing proceeds to step S4-9. At step S4-9, performance review packages will be prepared and shared with a particular manager and necessary changes will be made to obtain approval prior to sharing with direct reports.

Thereafter, at step S4-12, a determination will be made as to whether or not a particular manager needs to meet with his direct reports before such reports are permitted to review performance packages. If not, the performance review package containing peer review data, manager review and self review data will be submitted to the particular employee(s) under review.

If the determination at step S4-12 is positive and the outcome of step S4-3 is achieved, processing next proceeds to step S4-18.

At step S4-18, a performance review package will be prepared and a manager will be able to engage in a performance review meeting with each of his direct reports in accordance with established business practices.

Next, at step S4-17, a manager along with his direct reports may change their particular performance review packages based on feedback during performance review meetings and the like.

Next, at step S4-16, the MAP will be approved by the manager.

Next, at step S4-15, an employee will be given the opportunity to enter final comments about the performance review and approve the same via an online process.

Finally, at step S4-14, a manager and an employee will both save the MAP as a historical document in database server 110 and a new MAP may thereafter be created for the next review period, such as for the next year.

The following discussion refers to FIGS. 5A through 5KK, which are a series of screen images depicting online application screens and, in particular, graphical user interfaces facilitated by the systems depicted in FIG. 1. In particular, the screen images shown in FIGS. 5A through 5KK are browser screen images generated in accordance with applications served by application server 108 (FIG. 1) in conjunction with the other structures shown therein. In FIGS. 5A through 5KK, a circled item is intended to indicate the next process flow through traditional link traversal such as hypertext link traversal which is shown in the following screen image. Accordingly, for example only, FIG. 5 shows a circle on expectations setting and goals which will lead to the screen image shown in FIG. 5B. The screen images and the underlined applications depicted in FIG. 5A through 5KK are a preferred implementation of the overall process flows depicted in the flowchart shown in FIG. 4. Those skilled in the art of website design will immediately understand how to implement the HTML, Java Script and necessary script applications to facilitate the web pages and database access retrieval sequences that are shown in FIGS. 5A through 5KK.

Accordingly, as discussed with regard to FIG. 1, once a user at user system 102 is permitted access to application server 108 via security and other facilities 106, that user will be presented with a personal homepage (a front-end application page, etc.). In the case of a user named John Training, a homepage for that user will be depicted as shown if FIG. 5A to which reference now made. In FIG. A, a homepage generated in accordance with the overall processes discussed above with regard to FIG. 4 is shown. Here John Training will be able to enter and manage employee and project data online and throughout a review period in accordance with the present invention.

Upon link traversal under a goals setting link on the page shown in FIG. 5A, a user browser will traverse to a goals page as shown in FIG. 5B.

Here, a user will be able to establish expectations relative to job performance utilizing an online graphical user interface and online form facility (script based online form). Once a MAP has been created, the user may traverse a link such as a link identified as “improved communication across the department” to add data to that particular goal as shown in FIG. 5B.

Next, in FIG. 5C, a screen is shown where the user has selected the link “improved communication across the department” as shown in FIG. 5B and is entering data related to that particular goal. Next, link traversal shown in FIG. 5C will result in the screen shown in FIG. 5D. That is, key success factors for job performance are identified in FIG. 5D. Any one of the links shown in FIG. 5D may be selected and for purposes of example, driving for results factor 4 had been selected to arrive at the screen shown in FIG. 5E.

Once FIG. 5E is shown, links thereon may be traversed. Traversing the link for behavioral anchors in FIG. 5E will result in browser traversal to a behavioral anchor's page as shown in FIG. 5F. Any number of links may be selected but for purposes of example the back button has been selected to traverse to the screen shown in FIG. 5G.

In FIG. 5G, a user has selected driving execution as a traversable link to arrive at a web screen as shown in FIG. 5H.

In FIG. 5H, a development planning page, the user may select any number of links and has chosen to access the eAdvisor for action plan suggestions. The eAdvisor application provided by eAdvisor server 116 delivers development and coaching advise to users of system 100 and is facilitated via eAdvisor server 116.

As shown in FIG. 5I, the eAdvisor page has been manifested in user system 102. After a user has reviewed the information contained in FIG. 5I, he may operate a back button to return back to the screen image shown in FIG. 5H.

Referring now to FIG. 5J, depicted therein is a screen image of a page for peer selection in the expectation setting link as shown in FIG. 5A.

By traversing a process log link in FIG. 5J, a user will be presented with a page shown in FIG. 5K—a process log page. And by selecting goal link one for improving communication across the department, the user will be presented with a page as shown in FIG. 5L—process log page 2.

Next, a user may change the reviewer to access a page as shown in FIG. 5M. And as shown in FIG. 5N, the user may select peer feedback by clicking the appropriate link and accessing the peer feedback status page as shown in FIG. 5M.

Thereafter, the user may select a particular link for a particular person—here Rebecca Gotteberg to access a page as shown in FIG. 5O.

In FIG. 5O, a user may select the link for any number of key success factors and, for purposes of example, driving for results to access a page as shown in FIG. 5P. With reference to FIG. 5P, a peer review form will be presented whereby a user may engage in selection of any number of factors and may also select a link as shown on the left-hand side of the page shown in FIG. 5P. By selecting the select language link, a user will be presented with a page shown in FIG. 5Q. In FIG. 5Q, a user may setup to use a particular language for system operation. Also, a manager's toolbox may be selected by appropriate link traversal to access a page as shown in FIG. 5R.

In FIG. 5R—a manager's toolbox/also referred as “MY Direct Reports”—various reporting and system operations may be carried out by a manager. In particular, specifying data for a particular direct reports may be selected. As such, a direct report link for a one “Mary Training” may be selected by appropriate link traversal to access the web page shown in FIG. 5S.

In FIG. 5S, Mary Training's performance management and development activities data is shown for a manager. On this page as shown in FIG. 5S, the manager may select to review and/or enter data on goals, key success factors, development priorities, peer selection and may engage in particular approval feedback processes. For example, by link selection of goals for Mary Training, the manager or user will be presented with the page shown in FIG. 5T.

In FIG. 5T, expectation setting may be reviewed and managed by a manager by accessing goals and other information for that direct report. For example, further information may be accessed on key success factors by appropriate link traversal as indicated by the circled KSF to traverse to a page shown in FIG. 5U. In FIG. 5U, a manager may review and/or enter data related to key success factors for a direct report. Additionally, the manager may select development priorities for this particular direct report Mary Training. Development priorities are selected by appropriate link traversal to arrive at a page as shown in FIG. 5V.

In FIG. 5V, Mary Training's development priorities may be set and managed. Additionally, additional link traversal can lead a user to other areas of the system such as peer selection as shown in FIG. 5W.

In FIG. 5W, Mary Training's manager may add peers to her peer group who may be called upon to enter peer review data online to assist in conducting performance and accountability review.

A manager may also review a process log by selecting an appropriate link and traversing to a page as shown in FIG. 5X.

In FIG. 5X, a MAP progress log for Mary Training may be viewed. Any one of the links within the page shown in FIG. 5X may be traversed such as key success factors item number one for vision or strategic focus. When the circled link is selected a page as shown in FIG. 5Y will be displayed within user system 102. In FIG. 5Y, a manager may submit and manage data related to key success factors being managed for Mary Training.

Additional peer feedback may be selected for direct reports as shown in FIG. 5Z. In FIG. 5Z the manager may select any one of the peers pre-configured for providing feedback to Mary Training. Here, in FIG. 5Z, a manager may select Mary Pytko to access a corresponding page for feedback entry for Mary Training as shown in FIG. 5AA. If all feedback in a combined fashion is to be reviewed, selection of the circle link will cause a web browser in system 102 to access the page shown in FIG. 5B as served by application server 108 (FIG. 1).

Referring now to FIG. 5BB, 5CC, 5DD, 5EE, 5FF, 5GG, 5HH, 5II, 5JJ, and 5KK, depicted therein are additional screen images of the graphical user interfaces provided in accordance with the present invention to facilitate management of accountability and performance data related to employees and job functions within an organization. Those skilled in the art will immediately understand how to implement link pages including JavaScript applications to facilitate the operations depicted in 5A through 5KK.

The present invention permits replacement of conventional paper-based performance management systems. Accordingly, because the present invention permits an online environment in which to enter and manage employee accountability and performance data, several benefits are hereto realized:

Integration and linkage between the present invention and other corporate and business unit goals;

Integration and linkage between the present invention and leadership development;

Integration and linkage between the present invention and succession planning;

Realization of a year-round, on-going review process;

Simplification of the performance management process through the development of an easy to use tool that efficiently captures and combines input from various sources within an organization;

Alignment of individual performance with business goals and objectives by clarifying individual accountability and cascading goals and objectives down through an organization;

Provision of a platform for integrating and aligning existing HR processes such as succession planning, leadership and individual development, and employer of choice action plans; and

Enhance the meaningfulness of the review process by enabling and supporting a year-round feedback process and moving away from the event-based model currently in use.

Thus, having fully described the present invention by way of example with reference to the attached drawing figures, it will be readily appreciated that many changes and modifications may be made to the invention and to any of the exemplary embodiments shown and/or described herein without departing from the spirit and scope of the invention which is defined in the appended claims.

What is claimed is:

1. A system for managing employee accountability and performance, comprising:
an application server facility including at least one data processing platform configured to store and manage employee data, project management data related to a plurality of projects within an organization including employee evaluation and performance data, accountability data, peer review data, and application data related to a plurality of applications operable in conjunction with said employee data and said project management data; and
a client data processing facility coupled to said application server via a network, said client data processing facility configured to retrieve said application data from said application server facility and to facilitate generation of at least one corresponding graphical user interface within said client data processing facility and to permit access to and modification of said employee data and said project management data based on a predefined security scheme.

2. The system according to claim 1, wherein said application server facility is configured to store and manage said employee data, project management data, accountability data, peer review data, and application data in a database server facility coupled to said application server facility.

3. The system according to claim 1, wherein said network is a TCP/IP based network.

4. The system according to claim 3, wherein said TCP/IP based network includes the Internet.

5. The system according to claim 1, wherein client data processing facility is a personal computer running a web browser application capable of downloading content and application programs from said application server facility.

6. The system according to claim 1, wherein said client data processing facility is coupled to said application server facility via a wireless network connection.

7. The system according to claim 1, wherein said at least one graphical user interface is a online interactive screen provisioned within said client data processing facility.

8. The system according to claim 1, wherein said predefined security scheme contemplates the organizational position of a user prior to granting access rights to said user.

9. The system according to claim 1, wherein said application server facility is configured to store and manage said employee data, project management data, accountability data, peer review data, and application data based on a periodic review cycle.

10. A method for managing employee accountability and performance, comprising the steps of:
at an application server facility including at least one data processing platform, storing and managing employee data, project management data related to a plurality of projects within an organization including employee evaluation and performance data, accountability data, peer review data, and application data related to a plurality of applications operable in conjunction with said employee data and said project management data; and
at a client data processing facility that is coupled to said application server via a network, retrieving said application data from said application server facility and facilitating generation of at least one corresponding graphical user interface within said client data processing facility and permitting access to and modification of said employee data and said project management data based on a predefined security scheme.

11. The method according to claim 10, wherein said application server facility is configured to store and manage said employee data, project management data, accountability data, peer review data, and application data in a database server facility coupled to said application server facility.

12. The method according to claim 10, wherein said network is a TCP/IP based network.

13. The method according to claim 12, wherein said TCP/IP based network includes the Internet.

14. The method according to claim 10, wherein client data processing facility is a personal computer running a web browser application capable of downloading content and application programs from said application server facility.

15. The method according to claim 10, wherein said client data processing facility is coupled to said application server facility via a wireless network connection.

16. The method according to claim 10, wherein said at least one graphical user interface is a online interactive screen provisioned within said client data processing facility.

17. The method according to claim 10, wherein said predefined security scheme contemplates the organizational position of a user prior to granting access rights to said user.

18. The method according to claim 10, wherein said application server facility is configured to store and manage said employee data, project management data, accountability data, peer review data, and application data based on a periodic review cycle.

19. A system for managing employee accountability and performance, comprising:
an application server facility including at least one data processing platform configured to store and manage employee data, project management data related to a plurality of projects within an organization including employee evaluation and performance data, accountability data, peer review data, and application data related to a plurality of applications operable in conjunction with said employee data and said project management data; and
a client data processing facility coupled to said application server via a network, said client data processing facility configured to retrieve said application data from said application server facility and to facilitate generation of at least one corresponding graphical user interface within said client data processing facility and to permit access to and modification of said employee data and said project management data based on a predefined access scheme.

20. The system according to claim 19, wherein said application server facility is configured to store and manage said employee data, project management data, accountability data, peer review data, and application data in a database server facility coupled to said application server facility.

21. The system according to claim 19, wherein said network is a TCP/IP based network.

22. The system according to claim 21, wherein said TCP/IP based network includes the Internet.

23. The system according to claim 19, wherein client data processing facility is a personal computer running a web browser application capable of downloading content and application programs from said application server facility.

24. The system according to claim 19, wherein said client data processing facility is coupled to said application server facility via a wireless network connection.

25. The system according to claim 19, wherein said at least one graphical user interface is a online interactive screen provisioned within said client data processing facility.

26. The system according to claim 19, wherein said predefined security scheme contemplates the organizational position of a user prior to granting access rights to said user.

27. The system according to claim 19, wherein said application server facility is configured to store and manage said employee data, project management data, accountability data, peer review data, and application data based on a periodic review cycle.
